(19) United States
(12) Patent Application Publication
(10) Pub. No.: US 2002/0010743 A1
(43) Pub. Date: Jan. 24, 2002

(54) Method and system for distributing and collecting spreadsheet information

(76) Inventors: Mark H. Ryan, Scottsdale, AZ (US); David A. Keeney JR., Tempe, AZ (US); Ronald J. Tanner, Greenwood Village, CO (US)

Correspondence Address: Richard E. Oney, FENNEMORE CRAIG, Suite 2600, 3003 North Central, Phoenix, AZ, 85012, US

(21) Appl. No.: 09/780,599

(22) Filed: Feb. 10, 2001

Related U.S. Application Data
(60) Provisional application No. 60/181,725, filed on Feb. 11, 2000.

(51) Int. Cl. G06F 15/16; G06F 15/00; G06F 17/00

(52) U.S. Cl. 709/205; 707/503

(57) ABSTRACT

A method and system for communicating spreadsheet information between a distributor of a workbook and one or more contributors to the workbook is provided. A master workbook is created having one or more worksheets and assigning one or more contributors to each of the one or more worksheets. Embedded into each of the worksheets is a unique identifier for each of the one or more contributors to be assigned to the worksheet. The worksheets can then be distributed to the assigned contributors using the embedded identifier. After the assigned contributors receive the worksheets, each contributor can modify the received worksheets to which they have been assigned and return the modified worksheets to the distributor. The returned worksheets can be sorted and associated with the master workbook. The associated worksheets can be selectively merged into the master workbook.

### RELATED APPLICATIONS

This application claims the benefit of U.S. Provisional Application No. 60/181,725, filed Feb. 11, 2000, entitled “Method and System for Distributing and Collecting Spreadsheet Information,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates generally to spreadsheet systems for computing devices. More particularly, it relates to an improved method and system for communicating spreadsheet information between a distributor of the spreadsheet information and one or more contributors to the spreadsheet information.

A spreadsheet is a table of values or data arranged in rows and columns, which data can be text, numeric values, formulas, logic statements and various formatting characters. At the intersection of each column and row is a cell, which stores such data. In a spreadsheet, each cell can have a predefined relationship to the other cells. Thus, if a data value in one cell is changed, the data values in related cells also may need to be changed. A spreadsheet program is a computer program that allows the user to create and manipulate spreadsheets electronically.

Spreadsheets can be multi-dimensional. A multidimensional spreadsheet includes multiple spreadsheets that are linked to each other. For example, a three-dimensional spreadsheet can be depicted as a stack of spreadsheets in which the cells of each spreadsheet can be related to cells of the other spreadsheets in the stack. Such a multidimensional spreadsheet is often called a “workbook,” and each of the linked spreadsheets is called a “worksheet.”

FIG. 1 depicts a typical three-dimensional spreadsheet or workbook that includes multiple worksheets. Each worksheet is shown as a tabbed page in the workbook, with the tabs appearing at the bottom of the workbook. Each worksheet is divided into a rectangular grid made up of columns and rows. A letter assigned to each column appears in the column header just above the worksheet grid. A number assigned to each row appears in the header to the left of the worksheet grid. A cell is formed at the intersection of each column and row.

The cells form the basic building blocks of the worksheet. Each cell is assigned a unique set of coordinates consisting of its column and row number, called a cell reference. A cell reference serves as a pointer to a particular cell. When a cell reference is called by another cell, the referenced cell returns its value to the calling cell. Thus, one cell is able to obtain and use the numeric value of another cell by simply referencing it. Additionally, a cell may obtain and use the numeric values of a group of cells by referencing the area of the group. For convenience, the term “cell reference” will be used herein to refer to both references to a particular cell and to references to an area.

Information stored in a cell may be a number, text or the solution to a formula that is stored in the cell. The formula consists of mathematical operations to be performed along with any cell references for values required for the mathematical operations. The worksheet automatically calculates solutions for the formula by retrieving values of the cell references in the formula and performing the mathematical operations defined by the formula.

Because a formula is stored separately in the worksheet from any values used in the formula's computations, the formula need not be modified when the value of a referenced cell is changed. Rather, the solution for the formula need only be recomputed. Because the worksheet re-computes the solution automatically, the value calculated by the formula of a worksheet, the new data, remains current even after the underlying values, the existing data, have been changed. In the example of FIG. 1, each worksheet 29a, 29b,29c,29d,29e,29f,29g has been given a unique name with the Field Totals worksheet 29a acting as a summary sheet for the information contained on the other six worksheets 29b,29c,29d,29e,29f,29g that have geographic names. When numbers are added to the geographically-named worksheets, the values on the Field Totals worksheet 29a are automatically updated.

Spreadsheets perform a wide variety of tasks and have proliferated in businesses, homes, academia, and in many other environments. Some examples of business uses include the preparation of financial information and projections, such as the preparation of budgets and sales forecasts. The proliferation of spreadsheet use has been due, in part, to the ability of spreadsheets to calculate new data from existing data.

In using spreadsheets, it is often desirable for the originator of the spreadsheet to collect information for the spreadsheet from multiple contributors. For example, the originator may be a sales manager for a company that has a number of sales representatives responsible for different sales regions. The sales manager may be called upon to prepare sales forecast information. To do this, the sales manager may require each sales representative to submit a forecast for the representative's specific sales region. For another example, an originator of a company budget spreadsheet may have to collect budget information from several contributing groups or departments within the company to complete the budget for the entire company.

Previously, the originator of a spreadsheet could distribute a single workbook to one or more other contributors and collect input from those contributors in one of several ways. The originator could electronically route the original workbook to each contributor, one at a time, for that contributor's input. Alternatively, the originator could make the workbook available online simultaneously to all of the contributors as a shared workbook. For example, the Microsoft Excel spreadsheet program, marketed by Microsoft Corporation, allows all persons in a workgroup to have shared access to a workbook by placing the workbook on a network and designating the workbook as a shared workbook for a particular workgroup. In such a shared workbook, every authorized user in the workgroup can then input information into the entire workbook. Other spreadsheet programs, such as Lotus 1-2-3, marketed by IBM Corporation, and Quattro Pro, marketed by Corel Corporation, provide shared access to workbooks in a similar fashion.

Whether routing a workbook to each contributor or providing access to all contributors as a shared resource, prior systems have a significant drawback in that they allow every authorized user of a shared workbook to view all of the worksheets in the workbook. Providing such shared access to all contributors is often undesirable. For instance, an originator of a workbook containing departmental salary information may not want every contributor to see the salaries of all the other departments' employees. Likewise, in the example of the sales manager discussed above, the sales manager may not want each sales representative to see the forecast information of the other sales representatives. Although previous spreadsheet programs allow an originator to protect individual cells in a workbook from being changed, they do not allow the originator to protect those cells from being viewed. Thus, there is a need to be able to restrict access to individual worksheets in order to retain privacy of confidential information.

Prior systems also have presented drawbacks in collecting information from contributors and merging that information into the original workbook. Using those systems, contributors often provide their contributions by making changes to a copy of the workbook and then returning that modified workbook to the originator. If there are multiple contributors, each contributor will return their individual modified workbook. After receiving the modified workbooks, the originator typically then selectively incorporates each contributor's input into the original workbook by cutting the content from each of the modified workbooks submitted by the contributors and pasting that content into the original workbook. Although commonly used, this method is very inefficient and time-consuming.

Previous systems also have shortcomings in their ability to track changes made to worksheet content. Although spreadsheet programs previously have included features for tracking changes to worksheets, i.e., for tracking who modified a particular cell's value, these features do not allow the originator of the workbook to produce a history of content returned by individual contributors. In order to see older versions of a given worksheet, those older versions must have been saved under a different file name. It would be advantageous to a user, however, to be able to view a history of versions of the workbook and to be able to “roll back” or “roll forward” through that history in order to view a specific version of the workbook. Likewise, it would be advantageous to be able use that history to track changes, such as to produce a history of content returned by a given contributor.

Therefore, there exists a need in the art for an improved method and system for the automated distribution of spreadsheet data to multiple contributors and the automated collection of spreadsheet information from those contributors. Accordingly, it is an object of this invention to provide such an improved method and system.

It is a further object of the present invention to provide a method and system by which individual worksheets of a source workbook that is to be distributed, i.e. a master workbook, can be hidden from, or made visible and accessible to, selected recipients or contributors

It is another object of the present invention to provide a method and system by which spreadsheet information returned by the selected contributors can be associated with the master workbook.

It is another object of the invention to provide such a method and system that can track the master workbook and the returned spreadsheet information and can provide for selectively merging the returned information into the source workbook.

It is yet another object of the invention to provide such a method and system that can keep track of each version of the distributed workbook, including a history or content returned by contributors to the workbook.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a method and system for communicating spreadsheet information between a distributor of the workbook and one or more contributors to the workbook. The method includes creating a master workbook having one or more worksheets and assigning one or more contributors to each of the one or more worksheets. This includes embedding into each of the worksheets a unique identifier for each of the one or more contributors to be assigned to each worksheet. The worksheets can then be distributed to the assigned contributors using the embedded identifier. After the assigned contributors receive the worksheets, each contributor can modify the received worksheets to which they have been assigned and return the modified worksheets to the distributor. The returned worksheets can then be sorted and associated with the master workbook. The associated worksheets can then be selectively merged into the master workbook.

The system includes a storage device for storing the electronic workbook and a processor programmed to work in cooperation with the storage device. The processor is programmed to assign a contributor to a worksheet of the workbook by associating with the worksheet identifying information for the contributor, to associate with the worksheet distribution information for distributing the worksheet, and to distribute the worksheet to the assigned contributor based on the identifying information and the distribution information.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 shows a portion of a computer monitor display in accordance the invention, which includes a “Distributed Spreadsheet” menu choice and also includes a workbook having multiple tabbed worksheets.

FIG. 2 is a block diagram showing the components of a computing system used in connection with a spreadsheet distribution program in accordance with the present invention.

FIG. 3 is a flow diagram showing the process by which contributors are assigned to a worksheet of a workbook in accordance with the present invention.

FIG. 4 is a graphical depiction showing an example of the assignment of worksheets of a workbook to various contributors.

FIGS. 5A and 5B show computer monitor displays that illustrate the process by which contacts in a spreadsheet distribution address book are assigned as contributors to a worksheet in accordance with the present invention.

FIG. 6 shows a computer monitor display for adding contact information to the spreadsheet distribution address book.

FIG. 7 is a flow diagram showing the process by which a worksheet is distributed to the contributor assigned to the worksheet in accordance with the present invention.

FIGS. 8A through 8D depict computer monitor displays that illustrate the process by which a worksheet is distributed to the contributors assigned to the worksheet in accordance with the present invention.

FIG. 9 is a flow diagram showing the process for receiving and opening a worksheet that has been distributed in accordance with the present invention.

FIG. 10 shows a computer monitor display that provides the user interface for a contributor to receive and open a worksheet that has been distributed to the contributor.

FIG. 11 depicts the pull-down menu that appears when the “Distributed Spreadsheet” menu choice shown in FIG. 1 is selected.

FIG. 12 shows a computer monitor display that provides the user interface for a contributor to return a worksheet to the distributor.

FIG. 13 is a flow diagram showing the process for collecting contributions.

FIGS. 14A and 14B show computer monitor displays that provide the interface for a distributor to view workbook files that have been distributed to contributors, to review the status of returned contributions and to construct, view and compare workbooks that result from the merging of different selections of contributions.

FIG. 15 shows an example of a computer monitor display that presents the properties and status of a workbook file being viewed.

FIG. 16 shows a computer monitor display that provides the option of enabling or disabling the automatic inclusion of the email address book in the spreadsheet distribution address book.

FIG. 17 shows a computer monitor display for setting email distribution defaults.

FIG. 18 shows a computer monitor display for providing logging information and options.

### DESCRIPTION

Reference will now be made in more detail to the presently preferred embodiments and methods of the invention as illustrated in the accompanying drawings, in which like numerals refer to like parts throughout the several views.

### Glossary of Terms and Acronyms

The following terms and acronyms are used throughout the description:

Distributor. An individual who sends out a workbook to one or more other individuals for their review and/or input.

Contributor. An individual to whom a distributor sends one or more worksheets for a given workbook. A contributor can change or add data to the received worksheets and return the worksheets to the distributor. An individual can be either a distributor or contributor with regard to a workbook, depending upon the role the person is playing relative to the collection of data for the workbook.

Email address. An electronic mail address. Such an address will normally have a user name or entity name followed by an“@” symbol which is followed by some organization's domain name. Examples of email addresses include “jgeils@music.com” or “my.name@yahoo.com”.

MAPI. Messaging Application Programming Interface. MAPI is a messaging standard developed and promoted by Microsoft Corporation. Often referred to as Simple MAPI, the MAPI specification provides a programmatic interface for the submission and retrieval of e-mail messages as well as a programmatic interface for the launching and display of the MAPI address book. The interface, which is built into the Microsoft Windows operating system, enables different email applications on a given computer to operate together to each distribute email. As long as the applications are MAPI-enabled, they can share email messages with each other. Presently, popular messaging applications that also support MAPI include, but are not limited to, Microsoft's Outlook, Novell Groupwise, Netscape Messenger, Lotus Notes and Qualcomm's Eudora.

E-MAPI. Extended Messaging Application Programming Interface. E-MAPI specifies a programmatic interface to an email system for creating and displaying email address book information as well as sending and receiving email messages. E-MAPI differs from MAPI in that E-MAPI provides programmatic access to the email address book while MAPI does not. Presently, only Microsoft's Outlook e-mail application program supports E-MAPI.

Workbook. A file having one or more linked worksheets. Before the introduction of Microsoft Corporation's Excel 95 spreadsheet program, workbooks were commonly referred to as “spreadsheets.” Spreadsheets were tabular forms, as they are today, but were limited to a single tabular form per file. With its release of the Excel 95 spreadsheet program, Microsoft Corporation introduced the concept of a spreadsheet being comprised of multiple tabular forms, each with its own identifying tab. At that time, the term “worksheet” was adopted to refer to the individual tabular forms and “workbook” to refer to a file containing multiple worksheets. Thus, what was once called a “spreadsheet” is now called a “worksheet” and the term “workbook” refers to a single file that contains one or more worksheets. Workbooks that are formatted in the Microsoft Excel format are identified by filenames having the .XLS extension. For convenience, as used herein, the term “workbook” refers to files that can have multiple worksheets or spreadsheets, whether they are in the Microsoft Excel format or in another spreadsheet format. Likewise, the term “worksheet” refers to a single tabular form of a workbook, whether in the Microsoft Excel format or in another spreadsheet format.

Version. A specific, dated copy of a workbook that has been sent out to assigned contributors.

### System Components

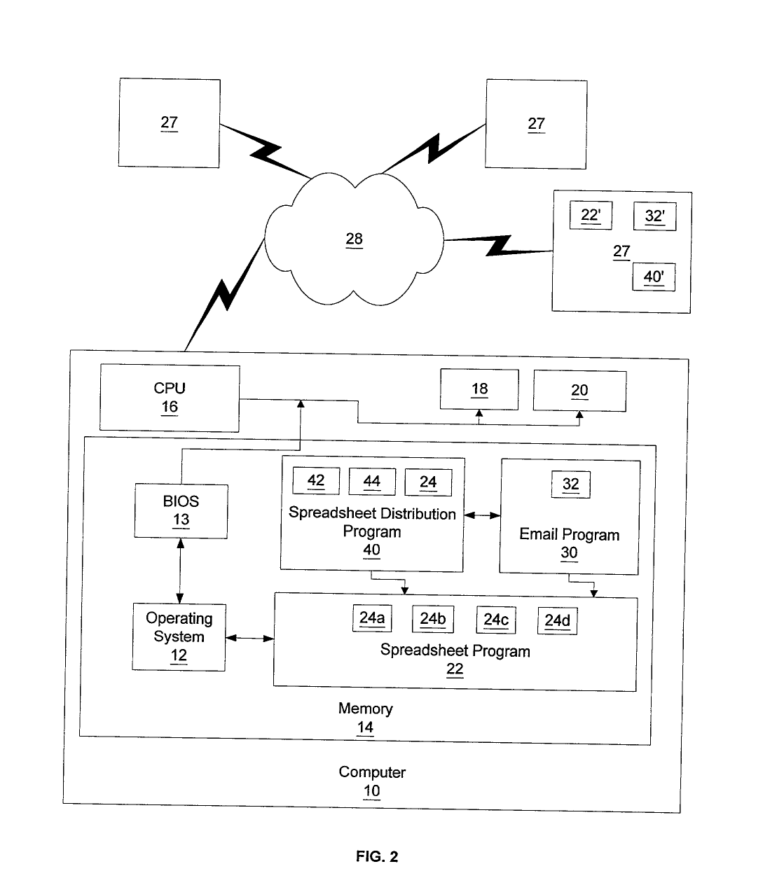

FIG. 2 shows the components of the preferred operating environment, a computer system, for use in connection with a spreadsheet distribution program in accordance with the present invention. As shown in FIG. 2, the computer system 10 comprises an operating system 12 stored on a memory device 14. The operating system 12 operates the computer system 10 in conjunction with a central processing unit (CPU) 16 to retrieve, process, store and display data. Data may be displayed electronically on a monitor 18 or a hard copy may be generated by a printer 20 as a result of data sent from the operating system 12 to the basic input/output system (BIOS) driver 13. The computer system 10 also includes an input device (not shown) such as a keyboard, mouse or voice recognition system. The computer system is configured in a known manner to communicate with other computers 27 via a communication medium 28. This can be accomplished by any means known in the art for allowing computers 10 and 27 to communicate via email, such as the Internet, a LAN, a WAN, or any other suitable computer network or email system.

Still referring to FIG. 2, a computer-implemented spreadsheet program 22 is stored on the memory device 14. The spreadsheet program 22 is called by the operating system 12 upon an input request by a user. Data is passed from the spreadsheet program to the CPU 16 and the BIOS driver 13 by the operating system 12.

As previously discussed, the spreadsheet program 22 includes one or more workbooks 24, which are stored in the memory device 14 as files. Each workbook 24 includes one or more worksheets 25a, 25b, 25c, 25d, each of which is divided into a rectangular grid made up of columns and rows. At the intersection of each column and row is a cell occupying that unique location on the worksheet. Each cell is assigned a unique set of coordinates consisting of its column and row number, called a cell reference. A cell reference serves as a pointer to a particular cell and, when the cell reference is called by another cell, the called cell returns its value. The value of a cell may be a number or text stored in the cell or may be the solution to a formula stored in the cell. A solution to the formula is automatically calculated by the worksheet by retrieving values of the cell references in a formula and performing the mathematical operations defined by the formula.

In the preferred embodiment, the spreadsheet program 22 is the Microsoft Excel 97 program or Microsoft Excel 2000, marketed by Microsoft Corporation. One of ordinary skill in the art, however, will recognize that numerous other types of spreadsheet programs could also be used to implement the present invention, including Lotus 1-2-3, marketed by IBM Corporation, and Quattro Pro, marketed by Corel Corporation, to name a few.

An email program 30 is also stored in the memory device 14. The email program 30 allows the computer 10 to send and receive email messages via the communication medium 28 to other the computers 27. Preferably, the email program 30 is E-MAPI-enabled or MAPI-enabled so that the email program 30 can share email messages with other MAPI-enabled email systems. This allows users who are collaborating on a given workbook to be on any of various email systems so long as they are MAPI-enabled. One suitable email program is the Outlook email program marketed by Microsoft Corporation, which supports E-MAPI. One of ordinary skill in the art, however, will recognize that numerous other types of email programs could also be used to implement the present invention, such as Novell Groupwise, Netscape Messenger, Lotus Notes and Qualcomm's Eudora, to name a few.

The email program 30 includes an email address book 32 for accessing stored contact information including contact names and email addresses. The email program is E-MAPI-enabled or MAPI-enabled, as discussed above, so that the spreadsheet program 22 and the spreadsheet distribution program 40 (described below) can access the content of the address book 32.

Also stored in the memory device 14 is a spreadsheet distribution program 40. The spreadsheet distribution program 40 is a software program that implements the logic and user interface for communicating spreadsheet information between a distributor of the workbooks 24 and one or more contributors to the workbooks 24.

The spreadsheet distribution program 40 supports interfaces with the email program 30 for sending, retrieving and collecting workbook 24. The spreadsheet distribution program 40 supports any email program that is MAPI-enabled and thereby allows users who are collaborating on a given workbook to be on any MAPI-supported email system. The spreadsheet distribution program 40 also includes an address book 42 for accessing stored contact information including contact names and email addresses.

The spreadsheet distribution program 40 includes directories having the following structure and functions:

. . . \Distributed Spreadsheet

This directory is the starting point for building the directory tree. It can be located on any storage device accessible to the computer system 10 and at any level in the existing directory structure of the computer system 10.

. . . \Distributed Spreadsheet\Collect Via File

This directory stores worksheets that are returned to a distributor through means other than email. The returned worksheet file (which is named with a .XDS extension) is placed in this directory to be processed during the collection function described below.

. . . \Distributed Spreadsheet\Distribute Via File

When the distribution function (described below) is executed, any contributors who are identified as “Via File” recipients will have their .XDS file stored in this directory as the default. The distributor has the option to locate the outbound .XDS file in any directory storage location accessible to the computer 10, including on any storage device accessible via a network. This directory is provided as a convenience and its usage is optional.

. . . \Distributed Spreadsheet\Distributor

This directory is the initial demarcation point for separating the files associated with each individual distributor.

. . . \Distributed Spreadsheet\Distributor\<username>\

Each distributor using the computer 10 has his or her own directory underneath the Distributor directory. Typically, there will be only one user per computer. However, this directory structure can accommodate those situations where multiple users share a computer but do not share a user name and all application files.

. . . \Distributed Spreadsheet\Distributor\<username>\<filename #1>

The spreadsheet distribution program 40 creates this unique directory for each workbook that is distributed. During normal usage, this directory structure can result in many directory folders located under the <username> directory. Following the operating system directory naming conventions, no two directories having the same parent directory may have the same name. All of the <filename> directories are displayed in the Analysis Center 162 (described below) within the Distributed Spreadsheets window 168.

. . . \Distributed Spreadsheet\Distributor\<username>\<filename #1>\<time and data stamp of distribution>

For each instance of a given workbook that is distributed, the spreadsheet distribution program 40 creates a directory underneath the directory coinciding to the name of the distributed workbook. For example, if a given workbook has been distributed on three separate occasions, there will exist three directories underneath \<filename #1>. Each such directory will have a unique name derived from the time and date of the distribution. All of the <time and date stamp of distribution> directories are displayed in the Analysis Center within the Versions window 170 (discussed below).

. . . \Distributed Spreadsheet\Distributor\<username>\<filename #1>\<time and data stamp of distribution>\<recipient #1>

For any given workbook that has been distributed, there will be at least one recipient acting as a contributor. The spreadsheet distribution program 40 creates this directory using the name of the recipient and his or her email address, or “Distribute Via File”, as the name of the directory. The uniqueness of the recipient's email address avoids conflicts in the directory-naming scheme.

. . . \Distributed Spreadsheet\Distributor\<username>\<filename #1>\<time and data stamp of distribution>\<recipient #1>\Sent.xls

The spreadsheet distribution program stores in this file a copy of the workbook as sent to the contributor. Retaining a copy of the workbook sent is preferable to mitigate situations in which the original message is lost, accidentally deleted or otherwise unavailable. The existence of a SENT.XLS file is used to trigger the inclusion of the recipient in the Check Contributor window 1 80 of the Distributed Spreadsheet Analysis Center screen 62 discussed below. If there is no corresponding RECEIVED.XLS file in the same directory, the entry will indicate <Not yet returned>.

. . . \Distributed Spreadsheet\Distributor\<username>\<filename #1>\<time and data stamp of distribution>\<recipient #1>\Sent.xds

The spreadsheet distribution program 40 stores in this file a copy of the encrypted workbook sent as an email attachment to a contributor. Included in this .XDS file is the actual workbook being sent. Retaining a copy of the sent workbook is preferable to mitigate situations in which the original message is lost, accidentally deleted or otherwise unavailable.

. . . \Distributed Spreadsheet\Distributor\<username>\<filename #1>\<time and data stamp of distribution>\<recipient #1>\Received.xls

The spreadsheet distribution program 40 stores in this file the workbook file as received from a contributor. The received file is renamed before being stored in this directory. The existence of a RECEIVED.XLS file is used to trigger indication of a successfully received contribution in the Check Contributor window 180 discussed below. The contributor's entry in the window will reflect the time and date stamp of the returned file rather than the time and date stamp of the original distribution.

The spreadsheet distribution program 40 uses logging as a means of providing a running history of application activity. As is known in the art, logging is a process of recording the actions taken by a given software application. The log file is a simple text file whose maximum size can be set by the user. When the log file reaches its maximum size, it is saved with an extension of OLD and a new file is created. Only the current log file and the most recent OLD version are retained. All other log files are deleted each time a new OLD file is created.

In the operation of the spreadsheet distribution program 40, two types of logging occur. The overall operation of the program 40 is recorded in a log file named DSLINK.LOG. In addition, there is also a log file for each version of a given workbook. This log file, named ACTIVITY.LOG, contains a running history of the distribution and collection of all workbooks of a given version. The log file is a text file that is easily viewed using any text editor. A sample of this log file is as follows:

12-06 15:48:21 Distribution Started.

12-06 15:48:23 File New Testing with files.xls Distributed to info@c-e-p-inc.com.

12-21 23:37:19 Collecting File New Testing with files.xls from AJ Ryan <ajryan@c-e-p-inc.com>.

12-21 23:37:19 Collect File New Testing with files.xls from AJ Ryan <ajryan@c-e-p-inc.com> Successful.

In the preferred embodiment, the distributed spreadsheet program 40 is written using Microsoft Visual Basic for Applications and Microsoft Visual C. It will be apparent to one skilled the art, however, that the distributed spreadsheet program 40 could be implemented using a variety of other suitable programming languages and application development tools.

Each of the computers 27 is configured similarly to the computer 10 and includes its own spreadsheet program 22′, spreadsheet distribution program 40′ and email program 32′.

### Spreadsheet Distribution Program Interface

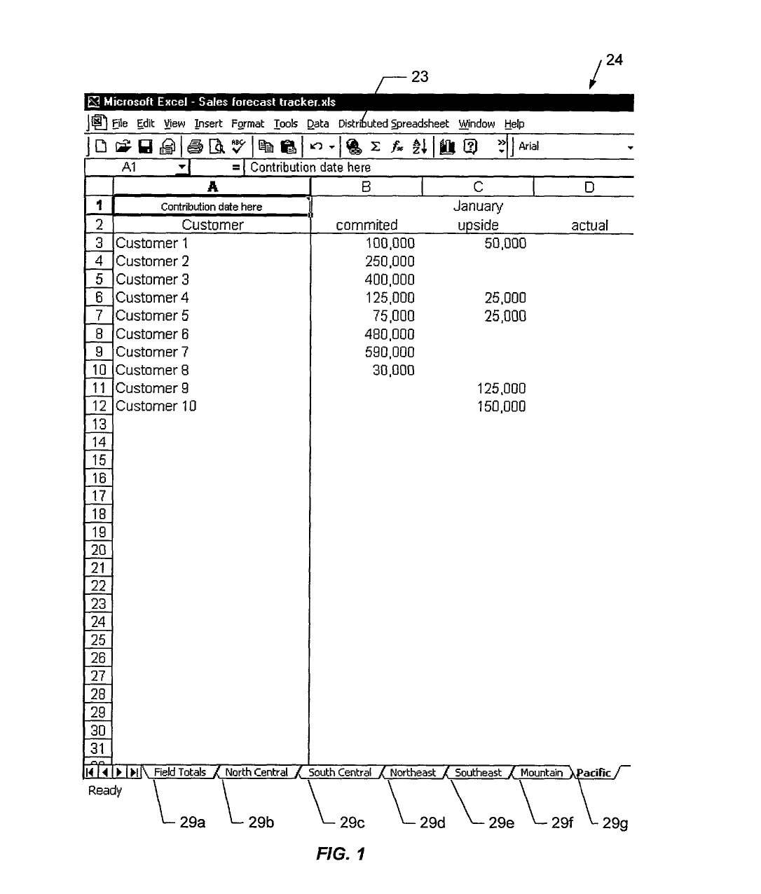

In the preferred method and embodiment of the invention, the spreadsheet distribution program 40 is initiated by launching the spreadsheet program 22. As is shown in FIG. 1, the spreadsheet program menu bar includes a Distributed Spreadsheet menu choice 23, from which the functionality of spreadsheet distribution program is accessed by the user. When the user clicks on Distributed Spreadsheet menu choice 23, the spreadsheet distribution program 40 displays the pull-down menu shown in FIG. 19, from which the user can access the functions discussed below.

### Assigning Contributors

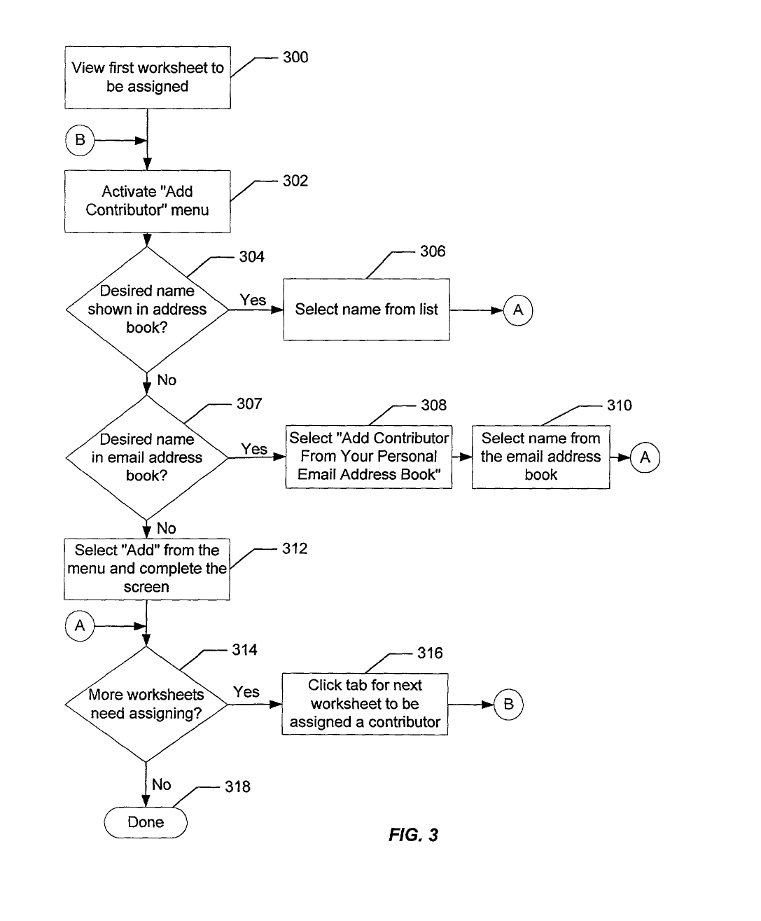

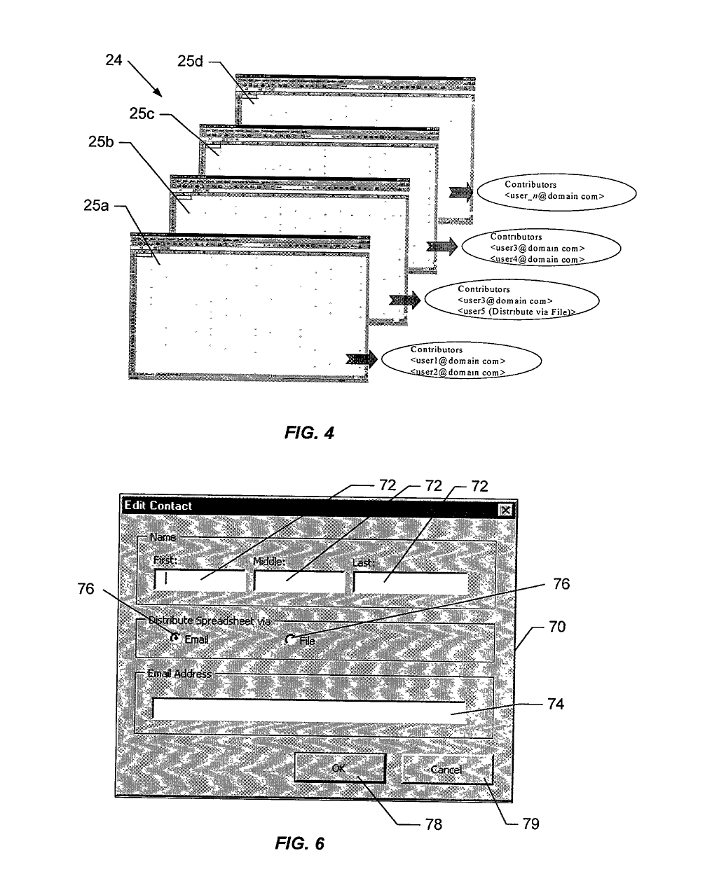

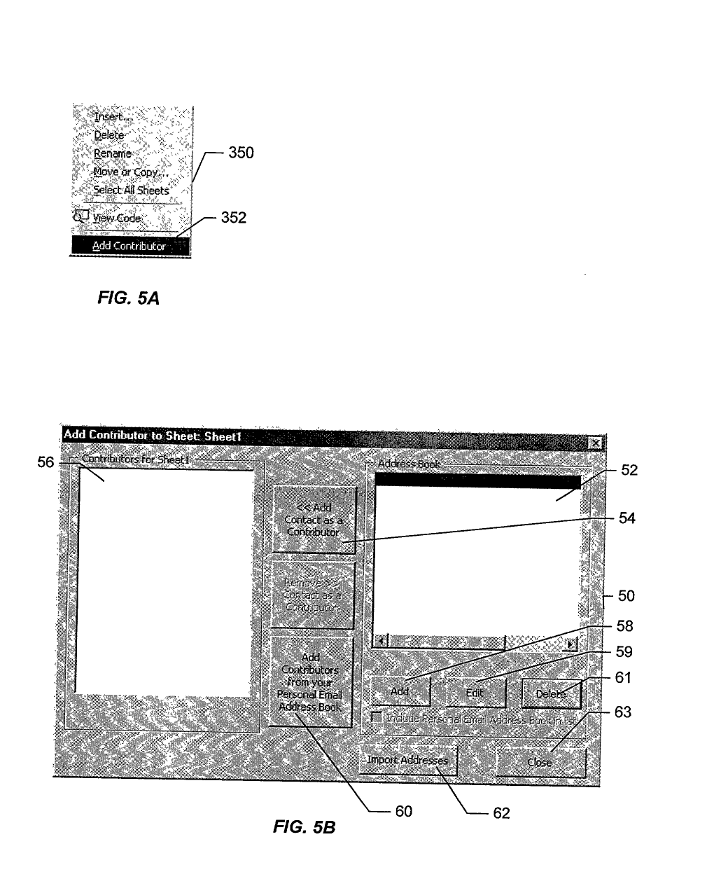

FIGS. 3 and 4 depict the process by which one or more contributors are assigned to worksheets 25 of a workbook 24 in accordance with the preferred method and embodiment of the present invention. FIG. 3 is a flow diagram of the process. FIG. 4 graphically depicts an example of the process wherein contributors designated as user1, user 2, user 3, user4, user5 and user_n are assigned to various of the worksheets 25. As shown in FIG. 4, one or more contributors can be assigned to each worksheet 25 of the workbook 24. FIGS. 5A and 5B show the preferred embodiment of the user interface for assigning contributors to a worksheet 25.

The spreadsheet distribution program 40 assigns contributors to a worksheet 25a by embedding into the worksheet 25a identifying information that is unique to each of the desired contributors. This identifying information is embedded so that the contributors will not be able to view or modify the identifying information. If the workbook 24, which includes the worksheet 25a, is to be sent by email, the identifying information embedded into the worksheet 25a includes the contributor's name and email address. If the workbook 24 is not to be sent by email, the identifying information embedded into the worksheet 25a includes a “Distribute by File” flag. When the workbook 24 is distributed, the spreadsheet distribution program 40 uses the “Distribute by File” flag to prompt the user to designate a file storage location at which the workbook 24 will be stored for access by the contributors. Each of the worksheets 25 can be assigned an unlimited number of contributors. However, a given contributor will only be able to view the specific worksheets 25 of the workbook 24 to which that contributor has been assigned.

In a preferred embodiment and method, the identifying information is embedded into the workbook 24 and the worksheets 25 as follows. The spreadsheet program 22, preferably Microsoft Excel, has a programmatic interface that allows a developer to embed name-value pairs into any workbook 24 at both the worksheet level and the workbook level. A name-value pair is a special type of worksheet cell known as a “key value pair,” which can be called by its name, if the name is known, but which is not displayed to a user when the workbook is viewed. The use of key value pairs to store content in an Excel workbook is explained in detail in the current Microsoft Development Guide, which is incorporated herein by reference. These name-value pairs function in a manner similar to the way a cell in a worksheet operates. As previously explained, in a worksheet, each cell has a unique, programmatic name associated with it. Associated with this name can be a value representing a number, a string of alphabetic characters, a formula or other data element. Name-value pairs function similarly except that the values are not visible and can only be displayed if the complete name of the name-value pair is known. This information is protected so that it cannot be accessed by the user.

The spreadsheet distribution program 40 uses name-value pairs to store within each workbook 24 information regarding contributors assigned to the worksheets of that workbook. The name-value pairs in each workbook 24 include all of the information necessary to properly distribute and return the workbook being distributed, including for example, the name of the distributor, the distributor's email address, the distributor's reply email address, special instructions, the master workbook name, the master workbook date, the due back date, information regarding how a distributed workbook was sent, the distribution status, information regarding when and how a contributor returned a workbook, information regarding when a distributor collected contributions, information regarding when a distributor merged contributions, and the like. Each of the worksheets 25 holds a name-value pair for the name(s) and the email address(s) of the assigned contributor(s). Each copy of the spreadsheet distribution program 40 has the capability to modify the name-value pairs as appropriate. Appendix A describes further detail regarding the name-value pairs used for the preferred embodiment and method of the invention, including their purpose, when they are created, and other information.

Referring to FIGS. 1, 3, 5A and 5B, to assign a contributor to the worksheet 25, the user first views the worksheet 25 to be assigned (step 300). The user then selects the Add Contributor menu option (step 302) as follows. The user can click on the worksheet tab 29, which produces the menu 350 shown in FIG. 5A, and select the Add Contributor option 352 from the menu 350. Alternatively, the user can select the Add Contributor option from the pull-down menu 354 of FIG. 11, which can be accessed by selecting the Distributed Spreadsheet menu choice 23 from the spreadsheet program toolbar.

In response, the spreadsheet distribution program 40 displays on the monitor 18 an Add Contributor screen 50, which is shown in FIG. 5B. The Add Contributor screen 50 is the interface for adding and removing contributors from a single worksheet. From the Add Contributor screen 50, the user can select contributors to be assigned to the worksheet 25 using an address book window 52 that displays the list of potential contributors stored in the distribution address book 42. The Add Contributor screen 50 also serves as the interface for building and accessing the distribution address book 42. The Add Contributor screen includes an Add button 58 which can be selected to add a contact to the distribution address book 42 as described below, an Edit button 59 for editing information for the contact highlighted in the address book window 52, and a Delete button 61 for deleting the contact highlighted in the address book window 52.

If the desired contributor's name is stored in the address book 42 (step 304), to assign that person as a specific contributor to the worksheet 25, the user selects that person's name from the address book list (step 306) by highlighting the contributor's name shown in the address book window 52 and clicking on the Add Contact as a Contributor button 54. In response, the spreadsheet distribution program 40 assigns the highlighted name to the worksheet 25 and displays the name of the assigned contributor in the Contributors window 56.

The Address Book window 52 displays contacts that have been manually entered into the distribution address book 42 and those that has been imported into the distribution address book 42 via an importation process, such as flat-file importation. If the desired contributor's name is not in the distribution address book 52 but is in the email address book 32 (step 307), the user can assign the person as a contributor to a worksheet 25 from the email address book 32 as follows. Again referring to FIGS. 3 and 5B, the user can click on the Add Contributors from Email Address Book button 60 (step 308). In response, the system will display the contact information from the email address book 32. The user can then select contacts from the email address book 32 and can assign them to the worksheet 25 (step 310) using the standard interface used to add recipients from an address book to an email message. Contact information also can be imported into the distribution address book 42 from the email address book 32. To do this, the user clicks on the Import Addresses button 62, which displays the contact information from the default MAPI email application, i.e., in this case the email address book 32. This is a standard MAPI screen and is well known in the art. The user can then select the contacts from the email address book 32 and import the selected names into the distribution address book 42. When the user has imported all of the desired contacts from the email address book 32, he or she can return to the Add Contributor screen 50. Once a name has been imported from the email address book 32, there is no need to repeat the importing process unless there are additional names that need to be imported that were not imported during prior sessions.

MAPI allows the address book to be viewed through the standard MAPI address book screen and does not support viewing the content in any other screen. E-MAPI, on the other hand, provides a function call that allows for the address book contents to be displayed in an external application screen. If the user has an E-MAPI application, the distribution address book 42 can include both its defined address book items as well as the entire content of the E-MAPI address book 32. When the user has only a MAPI application, the distribution address book 42 will not automatically display the user's email address book 32 until it has been imported into distribution address book 42. Thus, if the email program 30 supports E-MAPI, the content of the email address book 32 can be displayed in the distribution address book window 52 without the user having to display the content of the email address book 32 separately. This provides a convenient means of accessing the content of the email address book 32 from the Add Contributor screen 50. In addition, it allows the spreadsheet distribution program 40 to access the contact information that is stored in the email address book 32 through standard MAPI calls, which are well known in the art. In the Add Contributor screen 50 of FIG. 5B, the Include Personal Email Address Book in List check box allows the user to display in the distribution address book window 52 the contacts in both the distribution address book 42 and the email address book 32 when the default email client is an E-MAPI application.

If the user wishes to assign the worksheet 25 to a contributor who does not appear in the distribution address book 52 or the email address book, the user can manually add the desired contributor to the distribution address book 52 (step 312). To do this, the user can click on the Add button 58 of the Add Contributor screen 50. This launches the Edit Contact screen 70, shown in FIG. 6, which is the interface used to manually add a contact to the distribution address book 42. When the Edit Contact screen 70 appears, the user can input the new contact's name in the name fields 72 and can input the email address for the new contact in the email address field 74. By selecting from the option buttons 76, the user also can select the medium that the system will use to distribute a worksheet to the new contact. If the File option of option buttons 76 is selected, a prompt will occur when distributing a workbook asking for the location of the storage medium. By clicking on the OK button 78, the user stores this information in the distribution address book 42 and closes the Edit Contact screen 70. The Cancel button 79 cancels the edit operation, closes the Edit Contact screen 70 and returns to the Add Contributor screen 50.

If the user wishes to edit a contact who appears in the distribution address book 42, the user can click on the Edit button 59 of the Add Contributor screen 50. This launches the Edit Contact screen 70, shown in FIG. 6, with the information for contact highlighted in the distribution address book window 52 displayed in the fields of the Edit Contact screen 70.

Once a contributor has been assigned to the selected worksheet 25, the distributor can close the Add Contributor screen 50 by clicking on the Close button 66. To assign contributors to the remaining worksheets 25 of the workbook 24 (step 314), the user selects the next worksheet 25 to be assigned to a contributor (step 316) by clicking on the worksheet tab 29 of worksheet 25 and repeats the process described above for the worksheets 25. The user repeats this process until there are no more worksheets 25 that need to be assigned (step 318).

Before distributing the worksheets 25 to the assigned contributors, the distributor can change the assigned contributors for each of the worksheets 25. This is achieved by returning to the Add Contributor screen 50 and re-assigning contributors using the process for assigning contributors described above. Once contributors have been assigned to the worksheets 25, the workbook 24 is ready for distribution to the assigned contributors.

### Distributing a Workbook

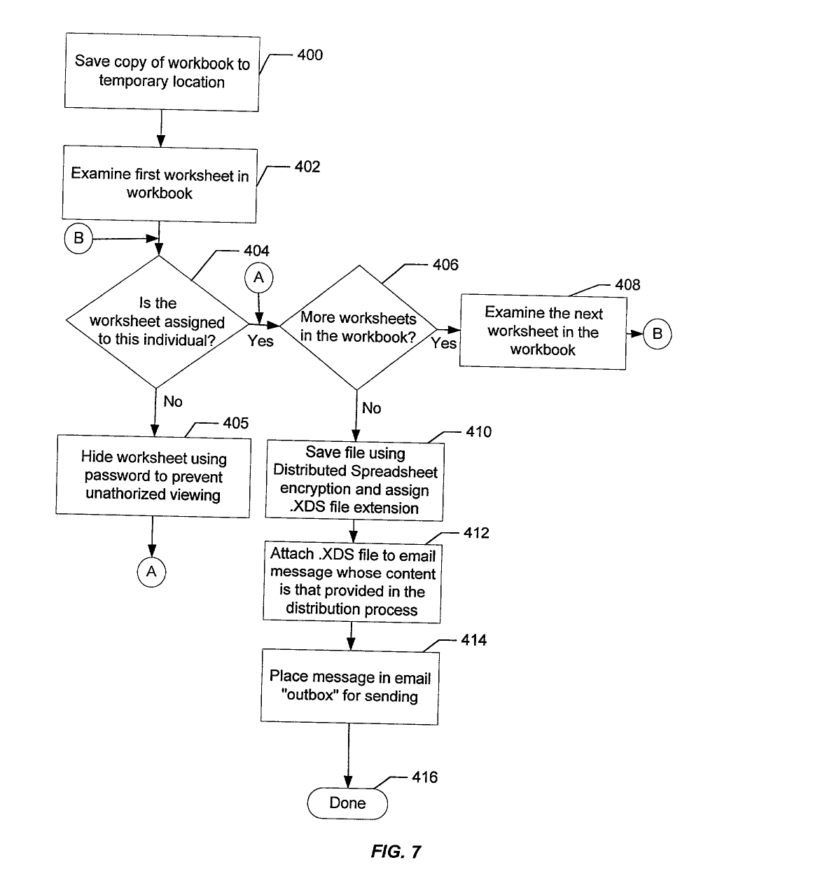

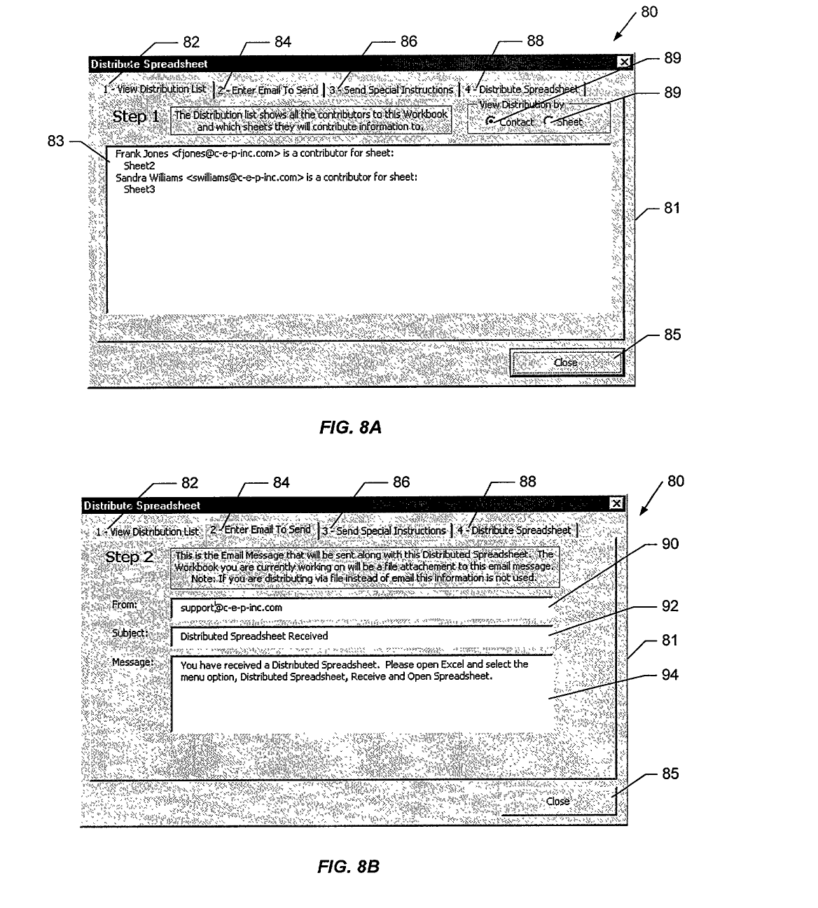

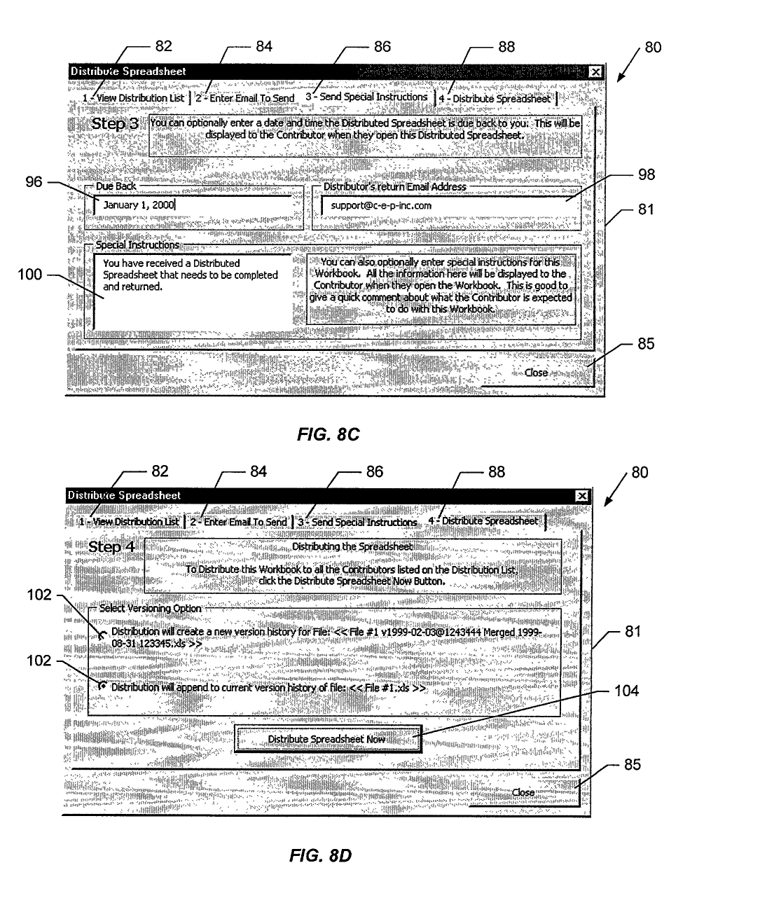

FIG. 7 depicts the process by which the worksheets 25 of the workbook 24 can be distributed to the contributors assigned to each of the worksheets 25. Generally, the process includes the steps of packaging each assigned worksheet 25, encrypting the worksheets 25 and sending the worksheets to the assigned contributors. FIGS. 8A through 8D show the preferred embodiment of a user interface 80 for distributing worksheets to contributors.

In accordance with the preferred method and embodiment of the invention, the assigned worksheets are packaged as follows. The spreadsheet distribution program 40 builds a recipient table 44 is built in the memory 14. The recipient table 44 stores the names of all of the contributors who are assigned to one or more of the worksheets 25, the delivery address of each contributor and the names of the worksheets 25 to which each contributor is assigned. Referring to FIG. 7, a copy 24′ of the master workbook file 24 is created and saved in a temporary location in memory 14 (step 400). The name of each of the worksheets 25a, 25b, 25c, 25d is then compared to the worksheet names stored in the first entry in the recipient table 44 as follows. The first worksheet 25a of the workbook copy 24′ is examined (step 402). If the name of the worksheet 25a is included in the worksheet names stored in the first entry of the recipient table 44 (step 404), it is then determined whether there are more worksheets in the workbook (step 406). If there are more worksheets, the next worksheet is examined (step 408) and step 404 is repeated. Referring again to step 404, if the selected worksheet is not included in the worksheet names stored in the first entry of the recipient table 44, the worksheet is then hidden and locked via a password (step 405). This is achieved as follows. The spreadsheet distribution program 40 includes a “password protect worksheet” attribute and a “hidden worksheet” attribute, which can be set for each of the worksheets 25. The spreadsheet distribution program 40 uses both of these to produce the appearance of a workbook containing a subset of the original worksheets. The password to access the hidden worksheet(s) is protected in a suitable manner to thwart access to the hidden worksheets by those unauthorized to have such access.

Once the worksheets are password protected and hidden, the workbook's “properties” page is modified. This is done to remove references to the hidden worksheets. Each workbook has a properties page that is provided by the spreadsheet program. This page lists, among many information items, all of the individual worksheets included in a given workbook. The spreadsheet distribution program 40 modifies the listing of included worksheets so that it displays only those worksheets designated to be received by the recipient. Since the recipient is unable to see the hidden worksheet(s) and does not have any way of discovering the contents of the hidden worksheets, an assigned workbook appears to the contributor to include only a subset of worksheets in the workbook, i.e. those worksheets to which the contributor has been assigned. Thus, only the worksheets to which the contributor has been assigned will be visible to that contributor.

The delivery address of the sender, recipient and return destination are embedded in the workbook along with the information that was previously embedded during the process of assigning contributors. This information can be further augmented by a message that the distributor desires each contributor to see before the contributor returns the workbook to the distributor.

After the worksheet is then hidden and locked as described above (step 405), it is then determined whether there are more worksheets in the workbook (step 406). Again referring to step 406, when there are no more worksheets in the workbook, the copied files 24′ are saved and encrypted (step 410) using an exportable encryption scheme, as is well known in the art. Each of the copied files 24′ is also given a .XDS file extension name (step 410).

If the worksheet 25 is to be delivered to the assigned contributor by email, an email message is created using the content supplied by the user during the Distribute Spreadsheet process (discussed below). The .XDS file 24′ is then attached to the email message (step 412) using the email program 30 in a conventional manner known in the art. The email message and attached .XDS file 24′ can be submitted to the email program 30 (step 414), using a MAPI function call, to be routed to the addressee along with other email messages created by the user.

If the worksheet 25 is to be delivered to the assigned contributor “Via File,” the .XDS file 24′ is placed in the “Distribute Via File” directory under the \Distributed Spreadsheet directory. No email message is created. Rather, the spreadsheet distribution program 40 displays a “Save As” dialogue box on the distributor's computer screen, which prompts the distributor to save a copy of the XDS file in the \Distributed Spreadsheet\Distribute Via File directory. The user can then store the .XDS file 24′ in the \Distributed Spreadsheet\Distribute Via File directory or any other directory storage location that is accessible to the user's computer. The name of the .XDS file 24′ will reflect the name of the original workbook 25, the name of the recipient and the time/date stamp of the .XDS file 24′ itself.

After the workbook 24 is distributed, whether by email or via file, the copied file is renamed SENT.XLS and placed in the \Distributed Spreadsheet directory structure according to the name and version of the original workbook 24 as well as the name of the recipient. As a result, the sender retains a copy of the workbook file that was sent.

The next entry in the recipient table 44 is then read and the process described above repeated for the contributor name stored in this entry. This process is repeated for each of the contributor name entries in recipient table 44.

By using the foregoing process, the spreadsheet distribution program 40 produces the appearance of saving individual worksheets into a series of workbooks and automates the distribution of multiple copies of a given workbook utilizing delivery information embedded within the workbook.

Referring to FIGS. 8A through 8D, to begin the distribution process, the user clicks on the Distribute Spreadsheet option from the Distributed Spreadsheet menu of FIG. 11. The spreadsheet distribution program 40 then displays a Distribute Spreadsheet screen 81, which includes a View Distribution List menu tab 82, an Enter Email to Send menu tab 84, a Send Special Instructions menu tab 86 and a Distribute Spreadsheet menu tab 88.

As shown in FIG. 8A, when the Distribute Spreadsheet screen 81 is first displayed it presents the View Distribution List menu tab 82 and a distribution list window 83, which displays the persons assigned as contributors to each worksheet for which there is an assigned contributor. By selecting the appropriate one of the View Distribution By option buttons 89, the user can display the distribution list sorted by contributor name or by worksheet. Any worksheet not assigned a contributor will not be shown. The distribution list window 83 allows the user to review the assigned contributors before sending out the worksheets to which the contributors have been assigned. If the distributor sees an improper assignment, he or she can click the Close button 85 to close the Distribute Spreadsheet screen 81, and can return to the Add Contributor screen 50 to make the necessary changes. Returning to the Distribute Spreadsheet screen 81 will display an updated list of assignees. Any worksheet that does not have an assigned contributor will not be sent to anyone. This allows the user to send only those worksheets that require a contributor to submit information. At any time when the Distribute Spreadsheet screen 81 is displayed, the user can click on the View Distribution List menu tab 82 to display the distribution list window 83.

Also from the Distribute Spreadsheet screen 81, the user can enter subject and message information to be attached to a worksheet that is to be distributed to contributors (step 412). To do this, the user clicks on the Enter Email to Send menu tab 84, which displays the screen shown in FIG. 8B, including a From address field 90, a Subject field 92 and a Message field 94. The information input into the From Address field 90 is the distributor's email address and is used to for the email log and the Reply To address. The information input into the Subject field 92 and the Message field 94 will be incorporated into the distribution and sent to all contributors as part of the email message. If there is a need to provide special instructions to the contributor, a special instructions message can be entered into the Subject field 92, for example to alert the recipient that he or she needs to read the message for important information. Once a Subject and Message have been attached to a worksheet, they remain associated with the message for all future distributions of the message. If the default From field 90, Subject field 92 and Message field 94 are changed using the Options selection of the Distribute Spreadsheet menu (see FIG. 11) these defaults will be applied only to worksheets not previously distributed.

From the Distribute Spreadsheet screen 81, the distributor also can send additional information that will accompany the spreadsheet being sent to contributors, such as a last-minute message to the contributors that will be displayed to the contributors before they return the worksheet to the distributor. To do this, the user clicks on the Send Special Instructions menu tab 86, which displays the screen shown in FIG. 8C, including a Due Back field 96, a Distributor's Return Email Address field 98 and a Special Instructions field 100. The return email address shown in the Distributor's Return Email Address field 98 can be changed if the user wishes. The distributor also can input in the Due Back field 96 the date by which the distributor wishes to receive the contribution and in the Special Instructions field 100 an optional message to be displayed to all contributors before they return the distributed spreadsheet.

To distribute worksheets to their assigned contributors, from the Distribute Spreadsheet screen 81 the user clicks on the Distribute Spreadsheet menu tab 88, which presents the display of FIG. 8D. This display includes a Distribute Spreadsheet Now button 104, can be used launches the process of bundling the various worksheets and messages for each contributor and submitting them to the outbound email queue. When the user clicks on the Distribute Spreadsheet Now button 104, this causes the distributed spreadsheet program 40 to create the individual email messages and save them in the appropriate email outbox of the email program 30 (step 414). When this process is complete (step 416), the distributed spreadsheet program 40 displays a Done box (not shown) with an OK button (not shown). The distributor then can acknowledge the sending process and return to the current workbook by clicking on the OK button.

The worksheets can be sent by invoking the conventional process of sending email. As is known in the art, this process can be achieved in a variety of ways, depending upon the user's environment. For example, in the case of a network user who is continually attached to a network email server, email is normally sent and received without user intervention - provided the email application is running. For a remote user, on the other hand, sending a message often involves establishing a connection to the Internet, loading the email application, and invoking the email sending function.

The spreadsheet distribution program 40 includes a versioning function that automatically saves a copy of every workbook that is distributed and every contribution that is returned. When a workbook file is distributed to its assigned contributors, a copy is retained for viewing. Each time a workbook is re-sent to contributors, a new, dated copy of the workbook is retained. The tracking of versions allows a given workbook to be re-sent to all contributors as a means of obtaining ongoing updates to the given workbook. If the distributor is re-distributing a previously distributed worksheet, the user has the option of appending the current version with a new set of available contributions or starting from scratch with a new workbook and a new history of versions. As shown in FIG. 8D, the Distribute Spreadsheet screen 81 includes Select Version Option buttons 102 for having the distribution create a new version history or append to the current version history.

### Receiving a Distribution

After a worksheet file has been distributed, either by email or by being stored in a shared file, the contributors assigned to the worksheet file can then receive the file. Generally, receiving a distributed worksheet file includes the steps of searching through the contributor's email program Inbox and opening all distributed spreadsheet messages sent from a distributor. There is no limit to the total number of messages that can be retrieved at any one time.

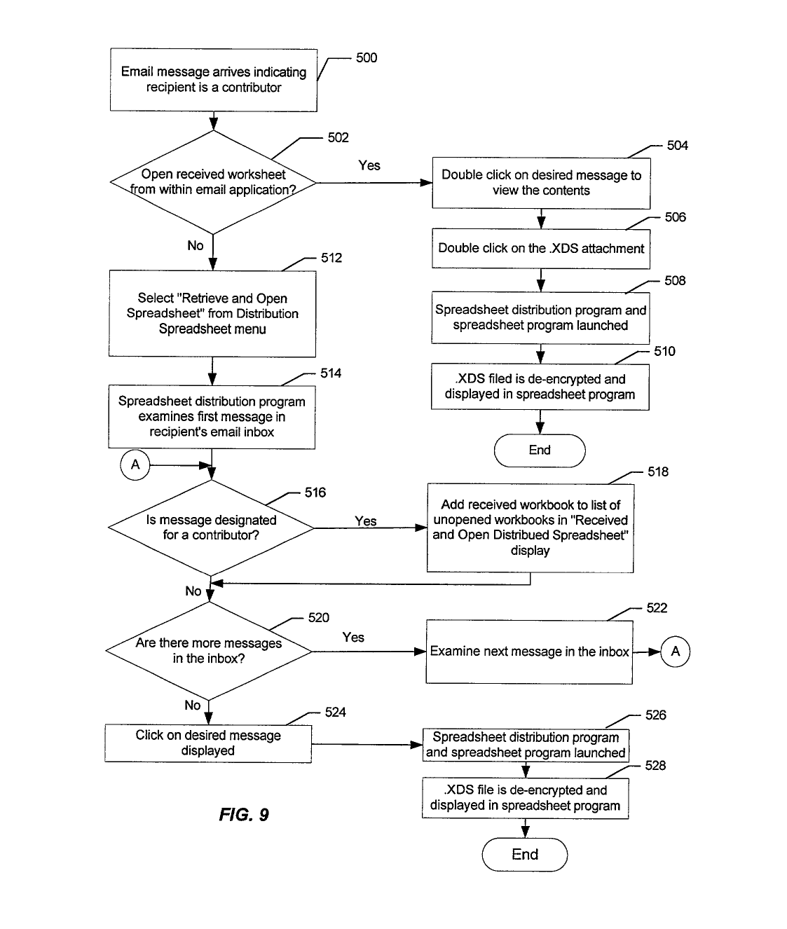

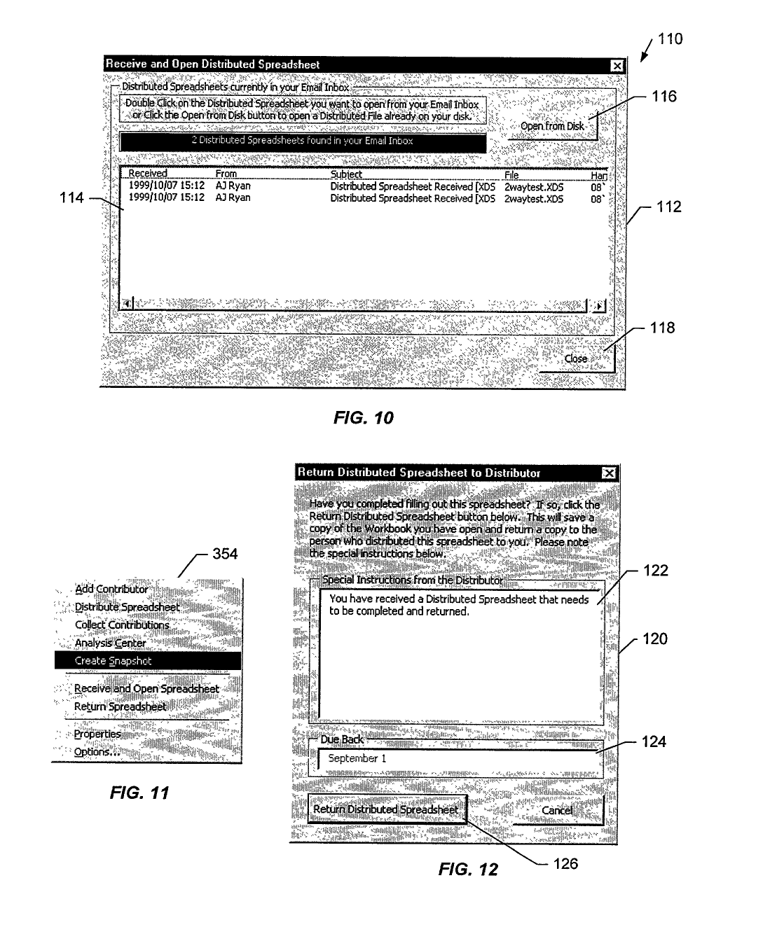

FIG. 9 shows the process by which the worksheets 25 of a workbook 24 can be received and opened by the contributors assigned to them. FIG. 10 show the preferred embodiment of a user interface 80 for receiving and opening worksheets assigned to a contributor. For purposes of this discussion it will be assumed that the contributor's computer is one of the computers 27.

When the contributor has received a distributed worksheet file via email (step 500), the received worksheet appears as an item in the contributor's email program Inbox. The contributor can open the worksheet and begin the process of filling in the requested information as follows. The received email message will include the distributed worksheet as an attachment. Such a message will be distinguishable from other messages due to the subject line and message body. The attachment will be a file with a .XDS extension and icon. If the user wishes to open the received worksheet from the email application (step 502) the user can double click on the desired email message to view the contents (step 504) and then double click on the worksheet attachment icon (step 506). This launches the contributor's spreadsheet distribution program 40′. If the contributor's spreadsheet program 22′ is not running, contributor's spreadsheet distribution program 40′ will launch the spreadsheet distribution program (step 508).

The spreadsheet distribution program 40′ un-encrypts the attachment and presents it for display by the contributor's spreadsheet program 22′ as a workbook with only those worksheets assigned to the recipient appearing to the recipient (step 510). Preferably, to prevent loss of the file through accidental deletion, the spreadsheet distribution program 40′ then prompts the recipient to save a copy of the received workbook at a location of the recipient's choosing. Once a worksheet file is retrieved, the spreadsheet distribution program 40′ permanently removes it from the contributor's email inbox.

Referring again to step 510, if the contributor already has the spreadsheet program 22′ open, the contributor can select the Receive and Open Spreadsheet option from the spreadsheet distribution program menu shown in FIG. 11 (step 512). The spreadsheet distribution program 40′ then displays the Receive and Open Distributed Spreadsheet screen 112 shown in FIG. 10 and executes a series of MAPI function calls to electronically read through the recipient's email Inbox looking for all messages that have a .XDS file as an attachment as follows. The spreadsheet distribution program 40′ examines the first message in the recipient's email inbox (step 514). If the message is designated for a contributor (step 516), i.e. if it is identified as “to Contributor,” it is added to a list of unopened workbooks and displayed in a Received window 114 on the Receive and Open Distributed Spreadsheet screen 112 displayed on the contributor's computer monitor. If there are more messages in the contributor's email inbox (step 520), the spreadsheet distribution program 40′ examines the next message in the inbox (step 522) and returns to step 516.

Again referring to step 516, if the examined email message is not designated for a contributor, the spreadsheet distribution program 40′ again determines whether there are more messages in the contributor's email inbox (step 520). If there are such messages, the spreadsheet distribution program 40′ examines the next message in the inbox (step 522) and returns to step 516. If there are multiple spreadsheet messages in the contributor's email inbox, the spreadsheet distribution program 40′ will display each of them in the Received window 114. In this way, the Receive and Open Distributed Spreadsheet screen 112 displays all of the messages in the email inbox that are requests from distributors for contributions.

Referring again to step 520, when there are no more messages in the email inbox and the complete unopened workbooks list has been created, the recipient can select a desired message to view. The recipient can do this from either the Open Distributed Spreadsheet screen 112 of the spreadsheet distribution program 40′ or from the recipient's email program. From the Open Distributed Spreadsheet screen 112, the recipient can double-click on the desired .XDS file shown in the Received window 114 (step 524) to open the .XDS email attachment. If the spreadsheet distribution program 40′ and the spreadsheet program 22′ are already running, the spreadsheet distribution program 40′ un-encrypts the workbook and displays it using the spreadsheet program 22′ (step 528). Also, from within the email program 30 the recipient can double click on the attachment to open the .XDS file. If either or both of the spreadsheet distribution program 40′ or the spreadsheet program 22′ is not already running, the unopened program is launched (step 526). The spreadsheet distribution program 40′ then un-encrypts the workbook and displays it using the spreadsheet program 22′ (step 528).

When a spreadsheet message is opened using the retrieve function of the spreadsheet distribution program 40′, the spreadsheet distribution program 40′ deletes the opened message from the email inbox, as explained below. If the spreadsheet message is opened using the email program 30, however, the spreadsheet message is not automatically removed from the email inbox. The spreadsheet distribution program 40′ automatically activates the Save As option to prompt the contributor to save the opened workbook. The Save As function is invoked only if the user has retrieved inbound requests for information directly through the spreadsheet distribution program 40′. Once the spreadsheet distribution program 40′ opens a retrieved incoming message, the message is removed from the user's email inbox so as to not waste disk space and clutter the inbox. If the user does not save the workbook file once it is opened, the workbook will be lost and the sender will need to re-send the workbook to the user. If the user double clicks on the attachment from within the email application, the .XDS file will be opened as described above, but without the email message and its attachment being removed from the inbox. This alternative, while avoiding the loss of a workbook, requires more storage capacity.

The recipient also can search for any .XDS files that have been delivered through means other than email. If a .XDS file has been distributed using the “Distribute Via File” process described above, rather than via email, the contributor can retrieve the .XDS file through the standard Windows “Browse” function. From the Receive and Open Distributed Spreadsheet screen 112 this is achieved by clicking on the Open from Disk button 116 and browsing through the connected resources until the file in question is located.

Once the retrieved .XDS file is opened, the contributor can modify the worksheets in that file assigned to him or her like any other spreadsheet by using the contributor's spreadsheet program 22′.

### Returning a Contribution to the Distributor

When the contributor has completed the changes to the retrieved workbook or has provided the requested information, the modified workbook can be returned to the distributor.

FIG. 12 shows a computer monitor display that provides a user interface for a contributor to return a worksheet back to the distributor in accordance with the preferred method and embodiment of the invention. The interface includes a Return Distributed Spreadsheet to Distributor screen 120 that can be used to remind the contributor of details and housekeeping items before returning the worksheet to its distributor. To launch the Return Distributed Spreadsheet to Distributor screen display 120, the contributor selects the Return Spreadsheet option from the Distributed Spreadsheet menu 354 shown in FIG. 11. The contributor's spreadsheet distribution program 40′ then displays the Return Distributed Spreadsheet to Distributor screen 120, which includes a Special Instructions from Distributor dialog box 122, a Due Back dialogue box 124 and a Return Distributed Spreadsheet button 126. The Special Instructions from Distributor dialog box 122 displays the instructions previously supplied by the distributor and embedded within the workbook 24′ during the distribution process. The Due Back dialogue box 124 displays the date that the distributor has requested the assigned contributor to return the workbook 24′. This date also can be used for electronic calendaring purposes. A Cancel button can be selected to close the Return Distributed Spreadsheet to Distributor screen 120 without returning the distributed spreadsheet.

To return the workbook 24′ to its distributor, the contributor clicks on the Return Distributed Spreadsheet button 126. The spreadsheet distribution program 40′then packages the workbook 24′ to be returned to the distributor as follows. The spreadsheet distribution program 40′ analyzes the embedded workbook information to determine the distribution medium by which the file was received, i.e. by email or “Via File”. A workbook received by email will be returned via email using the return email address provided by the distributor and embedded in the workbook file. A workbook file received as a separate file will cause a Windows “Browse” dialog box to appear, prompting the contributor to identify the location where the returned workbook file 24′ should be stored for later retrieval by the distributor.

The spreadsheet distribution program 40′ encrypts the workbook 24′ and gives the resulting file a .XDS extension. This file is either attached to an email message or saved at the location designated by the contributor. If the file is being returned via email, the subject line of the accompanying email message will indicate that the .XDS attachment is a returned contribution.

The spreadsheet distribution program 40′ will create an email message to the designated return address, encrypt and attach the workbook 24′ and post the message in the email outbox. The launching of the contributor's email application 30′ to send outbound messages is performed in a manner similar to that described above for distributing a workbook. Once the Return Distributed Spreadsheet button 126 has been clicked, the message is queued for the email program to send.

The returning process leverages the same capabilities previously described in the distribution process. Those capabilities include the manipulation of a workbook based on information encoded into the workbook itself. This information includes the contributor reminder message, return email address and return deadline. The subject line of the email message carries information that is used to programmatically differentiate between requests from distributors and responses from contributors.

### Collecting Contributions

After contributors assigned to a workbook have returned their contributions as files 24′ returned to the distributor, the returned files 24′ can be collected and re-associated with the master workbook from which the distributed copies were derived.

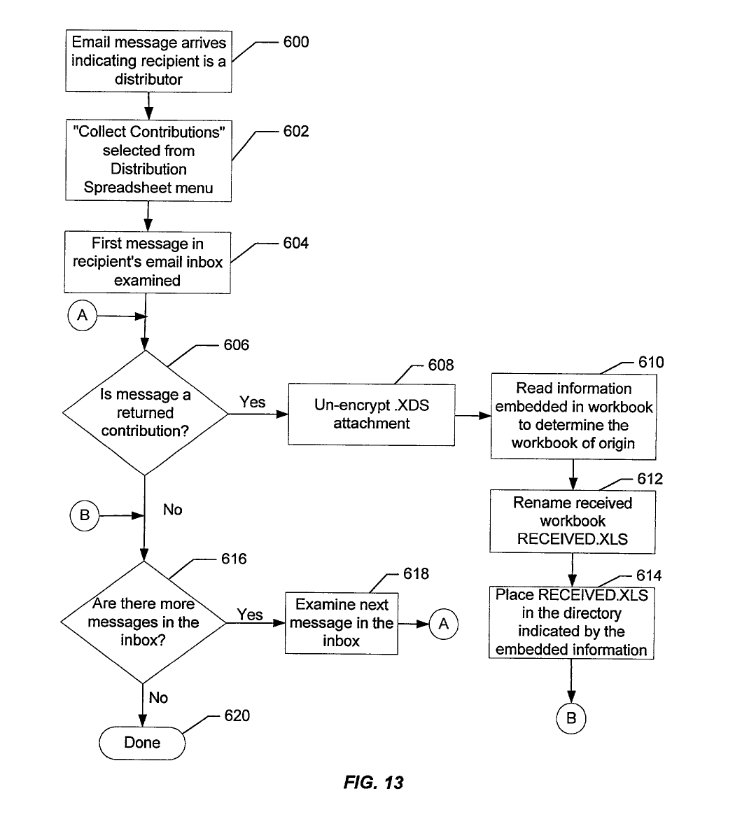

FIG. 13 is a flow diagram showing the process for collecting contributions. Each of the returned worksheets 24′ is attached to an email message that appears in the distributor's email inbox (step 600). Each returned worksheet 24′ is then automatically moved into the distributed spreadsheet environment as follows when the user initiates the collection process. When the user selects the “Collect Contributions” option from the Distributed Spreadsheet menu 354 shown in FIG. 11 (step 602), the user's inbox is automatically scanned for messages produced by the spreadsheet distribution program 40. The distributor's spreadsheet distribution program 40 does this by executing a series of MAPI function calls to electronically read through the recipient's email inbox looking for messages having a .XDS file as an attachment. All messages that have a .XDS attachment are further analyzed to determine which are requests for contributions and which are responses to such requests, which contain submittals of information from contributors. This is achieved as follows. The first message in the recipient's email inbox is examined (step 604) to determine if it is a returned contribution. If the message is a returned contribution (step 606), the attached .XDS file is unencrypted (step 608) and is further analyzed for its workbook of origin by reading the information embedded in the .XDS file (step 610). The received workbook is then renamed RECEIVED.XLS (step 612) and is saved the appropriate directory within the spreadsheet distribution program hierarchy based on the information embedded in the received workbook, i.e. it is saved in the same directory as the original master workbook (step 614). This process occurs without user intervention outside of the initial menu selection.

Referring again to step 606, if the examined email message is not a returned contribution, the spreadsheet distribution program 40 determines whether there are more messages in the recipient's email inbox (step 616). If there are more messages in the email inbox, the spreadsheet distribution program 40 examines the next message in the inbox (step 618) and returns to step 606. If there are no more messages in the email box, the process of reading the email inbox is done (step 620). Each time the collection function is initiated, the recipient's email inbox is read in its entirety and all submitted files are collected.

When the end of the inbox has been reached, the spreadsheet distribution program 40 looks for any files having the .XDS extension that are located in the . . . \Distributed Spreadsheet\Collect Via File\ directory. All .XDS files located are processed as outlined above.

In this way, the collection process utilizes the unique directory structure as a means of sorting and associating workbooks sent to contributors with contributions received from contributors. In this way, the spreadsheet distribution program can track the outbound and inbound movement of files.

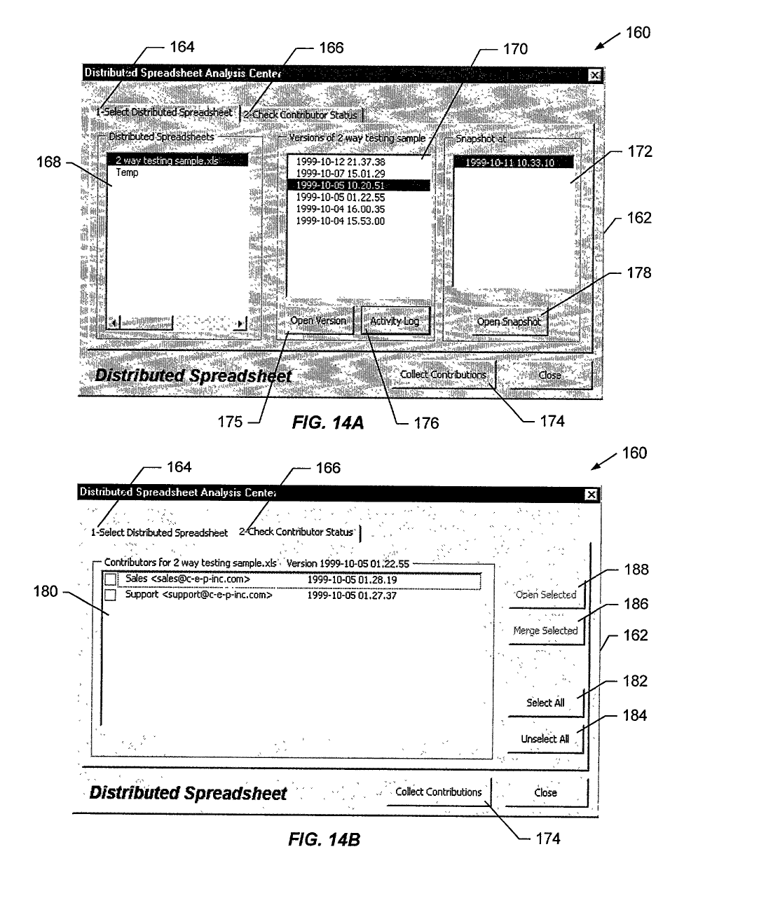

As explained above, the Collect Contributions option from the Distributed Spreadsheet menu 354 of FIG. 11 can be used to activate the collection function. Alternatively, the Analysis Center can be used to activate the collection function. FIGS. 14A and 14B show the Analysis Center computer screen display 162, which provides the interface for a distributor to view workbook files that have been distributed to contributors, to review the status of returned contributions and to construct, view and compare workbooks that result from the merging of different selections of contributions. The Analysis Center provides access to the complete listing of all distributed spreadsheets sent by the user to contributors. It includes all versions of each spreadsheet as will as snapshots. This provides a unique method of displaying the internal tracking mechanisms of the spreadsheet distribution program 40. It can be used to display which persons have provided contributed data for each workbook that has been distributed. Through the directory structure and file-naming scheme previously described, it is thus possible to quickly display the status of all workbooks that have been distributed. The result of the collection process will be indicated in a message box that will appear on the screens as shown in FIG. 14A and FIG. 14B. The operation of the Analysis Center is explained in more detail below.

### Merging Contributions into the Original Workbook

After the returned workbook files 24′ have been collected and re-associated with the master workbooks 24 from which they were derived, the information returned by the contributors in the returned files 24′ can be selectively merged with the relevant master workbook 24. The merge function allows the distributor to select the individually contributed workbooks to be merged thus providing an easy means for observing the changes occurring in the original workbook as each set of contributed data is incorporated. The spreadsheet distribution program 40 displays only those files that can actually be merged via the merging function of the spreadsheet program 22 and automatically flags the original workbook in an appropriate fashion to permit merging. The distributor is provided the option of selecting the specific contributed worksheets to be consolidated thus allowing the distributor to consolidate some contributions and forego consolidating others. In this way, the impact of specific worksheet contributions can be more easily viewed.

Merging one or more of the returned files 24′ with the master workbook 24 does not cause a permanent change to the master workbook 24. The results of the merge process are only temporary. Until saved, the modified copy of the workbook, which includes the merged information, is resident in memory only and not saved to disk. Contributions are not deleted and merged workbooks are given unique names so as to avoid overwriting existing workbooks. This modified working copy of the workbook can be saved using the Snapshot function described below.

In the preferred embodiment, the Analysis Center interface 160 (shown in FIGS. 14A and 14B) serves as the user interface for selecting the returned files 24′ to be merged into the master workbook. When a user of the Analysis Center interface 160 desires to merge contributed data into the master workbook, it is the Analysis Center that front-ends the spreadsheet program merge function and provides the means to selectively merge contributions with the master workbook, rather than the all or nothing approach previously utilized by the typical spreadsheet program user. In this way, the spreadsheet distribution program 40 enhances the merge function of the spreadsheet program 22 to provide a means of easily selecting the individual workbooks to be merged together. In addition, it provides a means of insuring that that which cannot be merged is kept separate from that which can be merged.

Previously, the merge functions of spreadsheet programs have been limited to merging workbooks together that originated from the same, shared workbook. Yet they have not provided any mechanism to indicate which workbooks that includes and which it does not. The spreadsheet distribution program 40 tracks the internal workbook information that the spreadsheet program uses to maintain the appropriate merge status of each workbook. The Analysis Center interface 160 allows the user to view all of the workbook files that the user has distributed to contributors, to review the status of returned contributions and to easily construct, view and compare workbooks that result from the merging of different selections of contributions.

The Analysis Center interface 160 is activated by selecting the Analysis Center option from the Distributed Spreadsheet menu shown in FIG. 11. The Analysis Center interface 160 includes an Analysis Center screen 162 that includes a Select Distributed Spreadsheet menu tab 164 and a Check Contributor Status menu tab 166. When the Analysis Center screen 162 opens, the Select Distributed Spreadsheet tab 164 is automatically selected and a Distributed Spreadsheets window 168, a Versions window 170 and a Snapshot window 172 are displayed. The Distributed Spreadsheets window 168 displays all the workbooks that the user has distributed to contributors. To select a distributed workbook into which to merge contributions, the user clicks on the desired workbook file displayed in the Distributed Spreadsheets window 168. When desired workbook has been selected, the Versions window 170 will display all of the versions of the workbook that have been distributed to contributors. For example, the Versions window shown in FIG. 14A reflects that the workbook file named “2 way testing sample.xls” has been distributed on six separate occasions. The name assigned to each distributed version of the workbook is the date and time that the distribution of the workbook occurred. For example, in FIG. 14A the highlighted reference “1999-10-05 10.20.51” represents a version of the workbook file named “2 way testing sample.xls” distributed on Oct. 5, 1999 at 10:33:10 PM. In this way, each version is distinguished by its unique time and date stamp.

Clicking on the Open Version button 175 will open the highlighted version of the workbook. In the spreadsheet distribution program 40, versioning is accomplished through the connecting of each request for data with the resulting submittals. Each request for submittal produces a history of returned content. This workbook versioning is accompanied by the capability to merge selected contributions into the associated workbook. Clicking on the Activity Log button 176 will open a window that displays a listing of the distribution and collection activities relative to the highlighted version of the workbook.

To select a specific version of a workbook file 24 into which to merge received contributions, the user clicks on the Check Contributor Status tab 166. The Analysis Center screen 162 will then present a Contributor Status window 180, as shown in FIG. 14B. The Contributor Status window 180 displays a complete listing of all requested contributions for the highlighted distributed spreadsheet and the highlighted version. Contributions with dates shown have been received back from the designated contributor. Contributions not yet received are identified as <not yet returned>. In this way, the Check Contributor Status tab 166 provides a list of identifying information for all of the contributors to whom the selected workbook version was sent, as well as information regarding the status of their contribution.

To view a returned file 24′ from a specific contributor, the user highlights the returned file 24′ shown in the Contributor Status window 180 and clicks on the Open Selected button 188. This will cause the spreadsheet program 22 to open and display the highlighted contribution as received so that its contents can be viewed independently of the other received contributions. This will not merge the received file 24′ into the master workbook 24 and will not inhibit the merging of the received file into the master workbook at a later time.

The Analysis Center screen 162 also includes a Collect Contributions button 174. When the user clicks on the Collect Contributions button 174, the spreadsheet distribution program 40 will open the user's email inbox and collect returned files that have been returned since a collection was last executed. This is beneficial, for example, if a specific contributor who has been delinquent in returning a contribution returns the contribution while the distributor is using the Analysis Center interface 160.

To select contributions to be merged, the user clicks on the desired contributions shown in the Contributor Status window 180 as having been received to highlight those contributions. If the user wishes to merge all of the contributions shown as received in the Contributor Status window 180, the user can highlight all of these received contributions by clicking on the Select All button 182. The Unselect All button 184 removes the highlighting from all received contributions in the Contributor Status window 180. If a contributor returned his or her workbook 24′ and then later returned a revised version of that workbook, only the latest version will be available, because the current version will be saved over the previous version.

Once the desired contributions displayed in the Contributor Status window 180 have been highlighted, the user can click on the Merge Selected button 186 to merge the highlighted contributions with the selected master workbook 24. The resulting workbook file will include the individual worksheets as returned from the contributors and all formulas, resulting in an updated workbook. Merging contributions does not effect the original master workbook. Instead, it produces a temporary version that can be saved via the Snapshot utility discussed below. Clicking on one or more received contributions and clicking on the Merge Selected button 186 thus produces a new workbook that reflects the originally distributed workbook 24 updated with the contributed data as selected. The title bar displayed in the spreadsheet program 22 with the new workbook reflects that a new workbook has been created, not as yet saved, and that the new workbook is named to include the name of the master workbook, the version identifier and the date the merging of contributed data occurred. Because this new workbook was created by selecting various options within the Analysis Center interface 160, it is not automatically saved. It can be easily re-created by making the same selections at a later date and merging.

Once the user has viewed the results of the initial merging of contributions, the Analysis Center 160 can be activated again to build a comparative workbook through the selection of a different set of contributions to merge. The Analysis Center 160 also provides an option to view the workbook as originally distributed as well as the raw contribution worksheet(s) from each contributor. If the spreadsheet program 22 can open multiple workbooks, the Analysis Center interface 160 can be used as explained above to open the master workbook, a workbook with all contributions merged and additional workbooks with different combinations of contributions merged together.

In this way, the spreadsheet distribution program makes merging a much simpler task for the user than with prior spreadsheet programs.

### Snapshot Function

On those occasions when the merge operation produces a workbook that needs to be saved as a new workbook, the spreadsheet distribution program 40 can provide a Snapshot function. This function allows for creating a new workbook from the results of merging one or more contributions into a given workbook. Current spreadsheet programs, such as Microsoft Excel, have the ability to allow the user to modify workbook content and immediately see the results. The distributed spreadsheet program 40 enhances that benefit by providing an easy way for the distributor to merge into a given workbook a selected set of contributions, see the result and capture that result to a new workbook. A “snapshot” is thus a unique workbook that reflects one or more contributions merged into a master workbook.

Unlike using the File-Save function in the spreadsheet program 22 to save various merged results, the snapshot function automatically names and stores the new workbook in a manner that allows quick access to the stored workbook at a later date. Rather than rely on personal memory or a confusing naming scheme to keep individual copies of the merge results, the Create Snapshot function is activated whenever a workbook produced from merging contributions is displayed.

To create a snapshot, the user selects the Create Snapshot option from the Distributed Spreadsheet menu 354 while viewing a merged workbook. The spreadsheet distribution program 40 then saves a copy of the workbook that contains the merged results. All snapshots are associated with the specific version of the master workbook underlying the merged results. Snapshots can be recalled using the Analysis Center screen 162.

When viewing the Analysis Center screen 162, snapshots associated with the workbook version highlighted in the Versions window 170 will be automatically displayed in the Snapshot At window 172. If the user selects a new workbook version from the Versions window 170, the list displayed in the Snapshot At window 172 will change accordingly. To open a snapshot, the user highlights the desired snapshot entry in the Snapshot At window 172 and clicks on the Open Snapshot button 178.

### Distributing Multiple Times

Occasions may arise when the most effective and efficient way to receive updated information to a previously distributed workbook is to re-distribute the workbook after all the initial contributions have been merged. In such a case, the file name of the merged workbook is different from the original file name.

Again referring to FIG. 8D, the distribution function provides an option when re-distributing a previously distributed workbook to append the re-distribution to the version history of the master workbook that was originally distributed or to start a new version history with a new master workbook. The alternative for receiving periodic updates to previously distributed workbooks is to re-distribute the original master workbook. In cases where editing the originally submitted material is all that is required, this method causes the contributor to re-create the contribution each time an update is requested.

While certain preferred embodiments and methods of the invention have been described, these embodiments and methods have been presented by way of example only, and are not intended to limit the scope of the present invention. For example, although described herein with reference to the Microsoft Excel spreadsheet program, the system and method of the invention can be used in other types of spreadsheet programs. Additional advantages and modifications will readily occur to those skilled in the art. Accordingly, departures may be made from details described herein without departing from the spirit or scope of the general inventive concept, and the breadth and scope of the present invention should be defined only in accordance with the following claims and their equivalents.

### Additional Functions of the Distributed Spreadsheet Menu

In addition to those functions discussed above, the Distributed Spreadsheet menu 354 shown in FIG. 11 also provides the means for accessing the following functions.

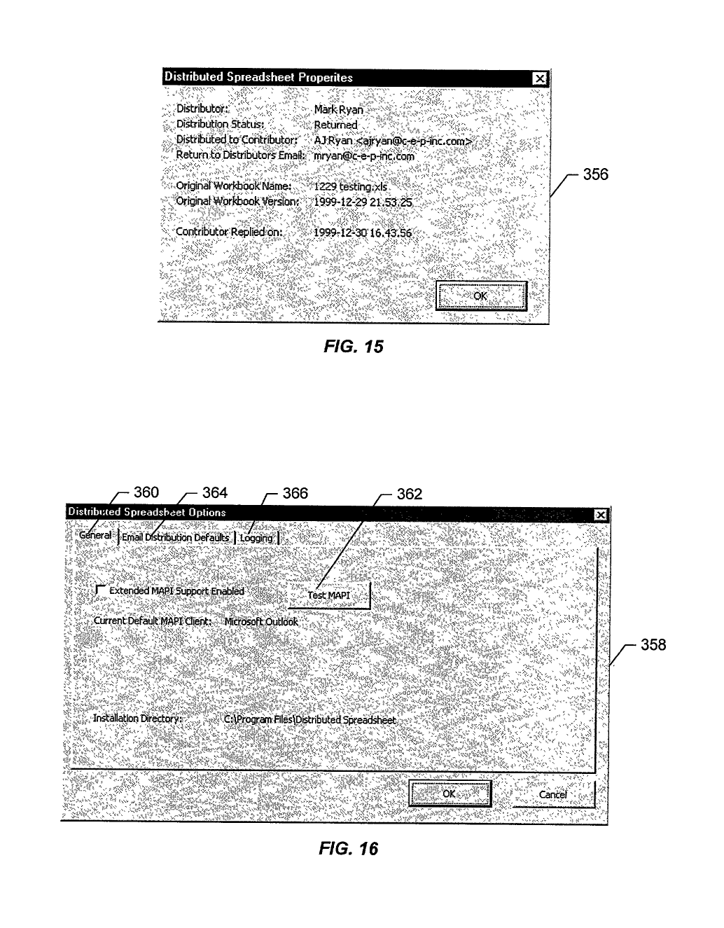

Selecting the Properties option from the menu 354 will cause the spreadsheet distribution program 40 to display a Properties screen 356 that displays the status of the workbook currently being viewed. An example of the Properties screen 356 is shown in FIG. 15.

Selecting the Options option from the menu 354 will cause the spreadsheet distribution program 40 to display a Distributed Spreadsheet Options screen 358. FIGS. 16 through 18 show the operation of the Distributed Spreadsheet Options screen 358. As shown in FIG. 16, the Distributed Spreadsheet Options screen 358 includes a General tab 360 that displays general installation information as well as provides the option to enable/disable the automatic inclusion of the email address book in the spreadsheet distribution address book. A Test MAPI button 362 is included to verify that the spreadsheet distribution address book is able to properly access the MAPI interface provided by the installed email application.

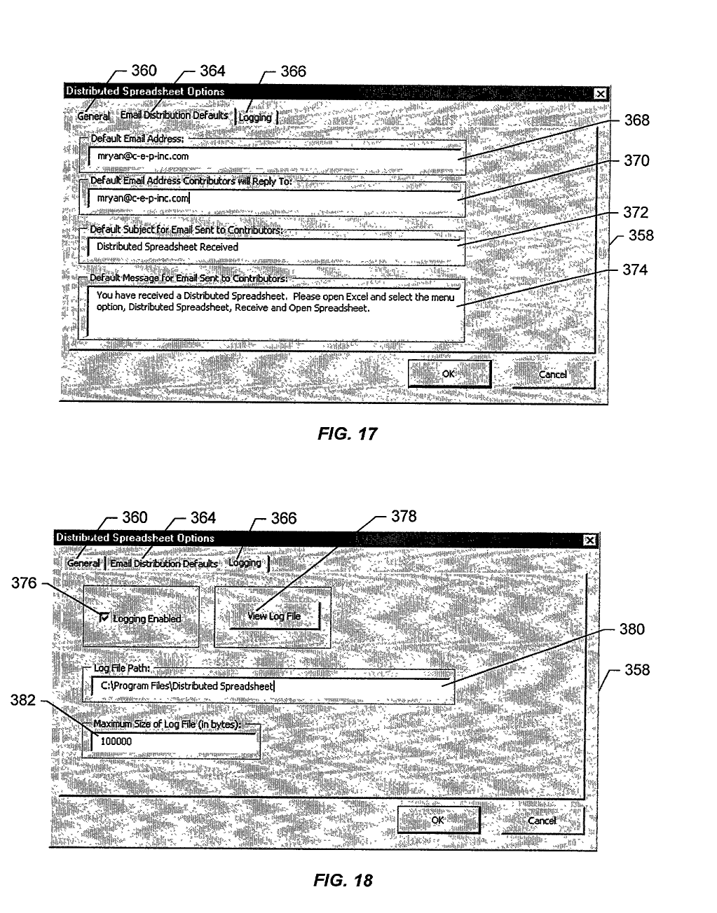

The Distributed Spreadsheet Options screen 358 also includes an Email Distribution Defaults tab 364. As shown in FIG. 17, the Email Distribution Defaults tab 364 includes a Default Email Address field 368, a Default Email Address Contributors will Reply To field 370 and a Default Subject for Email Sent to Contributors field 372. These fields are hold information that is used in the creation of the email message that accompanies a distributed workbook. The user can change the information in these fields as desired. The Default Email Address field 368 holds the user's email address provided during installation. The Default Email Address Contributors will Reply To field 370 holds the email address where all contributions should be directed. This field contains the Default Email Address by default, but it can be changed if the creator of the distributed workbook is someone other than the receipt point for all contributions. The Default Subject for Email Sent to Contributors field 372 holds a message that is entered in the subject line of an email sent with an attached distributed workbook. This can be used to identify that a distributed workbook has arrived or its importance and to help the recipient understand the importance and priority. The Default Message for Email Sent to Contributor field 374 holds a default message to accompany each distributed workbook. The content of the fields 368, 370, 372, 374 is embedded within a workbook the first time it is distributed. Changes to these fields are reflected only in newly created workbook and are not be reflected in previously created and distributed workbooks.

The Distributed Spreadsheet Options screen 358 also includes a Logging tab 366. As shown in FIG. 18, the Logging tab 366 includes a Logging Enabled checkbox 376, a View Log file button 378, a Log File Path field 380 and a Maximum Size of Log File field 372. Logging produces a running history of the internal operation of distributed workbook. The log file that is produced is entitled DSLINK.LOG. When the log file exceeds the maximum size parameter, the file is renamed DSLINK.OLD and a new log file is created. If a DSLINK.OLD file exists when the current log file exceeds the maximum size threshold, the existing DSLINK.OLD file will be deleted to make way for the new DSLINK.OLD file. The user can enable and disable the logging feature using the Logging Enabled checkbox 376. The Log File Path field 380 holds the full path name indicating the location where the log file will be saved. The default value is the program installation location. The log file can be viewed by clicking on the View Log file button 378. The Maximum Size of Log File field 382 can be used to set the maximum file size for the log file. When this size is exceeded, the file will be renamed DSLINK.BAK and a new DSLINK.LOG created.

APPENDIX A
Name/Value Documentation
Note: All Values are stored at the Workbook level unless otherwise noted in “Created When/By”.

| Name | Example Value | Description | Purpose | Created When/By | File |
|---|---|---|---|---|---|
| Name can be arbitrarily | Mark Ryan | Contributor | Contains the Key of the | When you add a | Active |
| selected | <mark@yahoo.com> | | contributor for a sheet | contributor to a | Workbook |
| | | | | sheet | |
| | | | | Note: Stored in | |
| | | | | the Sheet, not a | |
| | | | | the workbook | |
| | | | | level | |
| Name can be arbitrarily | Joe D. Bozo | Distributor | Contains the name of | When you | Master.xls |
| selected | | Name | the distributor of the | distribute the | |
| | | | workbook | workbook | |
| Name can be arbitrarily | Joe@bozo.com | Distributor | This is the email | When “Distribute | Active |
| selected | | Email Reply to | address that the | Spreadsheet” is | Workbook |
| | | Address | workbook will be | selected the first | |
| | | | returned to when a | time | |
| | | | Contributor has | | |
| | | | finished and returns the | | |
| | | | workbook | | |
| Name can be arbitrarily | Here are the 1999 | Special | this contains special | When “Distribute | Active |
| selected | sales projections. | Instructions | instructons that the | Spreadsheet” is | Workbook |
| | Please update your | | Distributor has entered | selected the first | |
| | departments | | for the Contributors. | time | |
| | number. | | | | |
| Name can be arbitrarily | 1999-05-04 18:00:00 | Due Back | This is when the | When “Distribute | Active |
| selected | | | Contributors should | Spreadsheet” is | Workbook |
| | | | have returned the | selected the first | |
| | | | Distributed | time | |
| | | | Spreadsheet back to | | |
| | | | the Distributor | | |
| Name can be arbitrarily | Workbook1 | Master | This is used when the | When you | Master.xls |
| selected | (No extension) | Workbook | file comes back to the | distribute the | |
| | | Name | distributor so it can be | workbook | |
| | | | placed in the correct | | |
| | | | directory. Used in | | |
| | | | conjunction with | | |
| | | | “Master Workbook | | |
| | | | Date”. | | |
| Name can be arbitrarily | 1999-04-28 18.30.45 | Master | This is used when the | When you | Master.xls |
| selected | | Workbook Date | file comes back to the | distribute the | |
| | | | distributor so it can be | workbook | |
| | | | placed in the correct | | |
| | | | directory. Used in | | |
| | | | conjunction with | | |
| | | | “Master Workbook | | |
| | | | Name”. | | |
| Name can be arbitrarily | | Distributor | This is the serial | When you | Master.xls |
| selected | | Serial Number | number of the software | distribute the | |
| | | | the Distributor is | workbook | |
| | | | running. | | |
| Name can be arbitrarily | E | Distributed via | This is how this file that | When you | Sent xls |
| selected | (E = E-mail, F = Fax) | | is being created by the | distribute the | |
| | | | Distribute Spreadsheet | workbook | |
| | | | functions was sent | Note: When | |
| | | | | distributed | |
| | | | | the file will be | |
| | | | | created in the | |
| | | | | “Outbox Directory” | |
| | | | | and be named: | |
| | | | | Original Workbook | |
| | | | | Name + Original | |
| | | | | Work Date + | |
| | | | | Distributed to | |
| | | | | Contributor | |
| Name can be arbitrarily | Joe D. Bozo | Distributed to | This is the key to the | When you | Sent.xls |
| selected | <joe@bozo com> | Contributor Key | Contributor. This is | distribute the | |
| | | | also the name of the | workbook | |
| | | | directory this file will be | | |
| | | | put into when the file is | | |
| | | | returned to the | | |
| | | | Distributor | | |
| Name can be arbitrarily | D | Distribution | This value is set as the | Set to D when the | Master.xls |
| selected | (D = Distributed, | Status | file moves through the | workbook is | |
| | R = Replied | | distribution process. | distributed. | |
| | C = Collected | | Set to R when the | | |
| | M = Merged) | | Contributor returns | | |
| | | | the workbook. | | |
| | | | Set to C when the | | |
| | | | Distributor collects | | |
| | | | the workbook. | | |
| | | | Set to M when the | | |
| | | | Distributor merges | | |
| | | | the workbook. | | |
| | | | Note: This | | |
| | | | workbook could be | | |
| | | | merged more than | | |
| | | | once but this Value | | |
| | | | will still be set to M. | | |
| Name can be arbitrarily | 199-04-28 18.30.44 | Contributor | This is the date/time | When the | Sent.xls that |
| selected | | Replied Date | when the Contributor | workbook is | Contributor |
| | | | Replied. This is when | returned to | has |
| | | | Distribution Status | Distributor. | |
| | | | changed to “R” | | |
| Name can be arbitrarily | 199-04-28 18.30.44 | Distributor | This is the date/time | When Distributor | Received.xls |
| selected | | Collected Date | when the Distributor | collects the | |
| | | | collected this file. This | workbook. | |
| | | | is when Distribution | | |
| | | | Status changed to “C” | | |
| Name can be arbitrarily | 199-04-28 18.30.44 | Distributor | This is the date/time | When the | Received.xls |
| selected | | Merged Date | when the Distributor | Distributor merges | and Master |
| | | | merged this file. This is | the workbook. | Merged.xls |
| | | | when Distribution | | |
| | | | Status changed to “M⇄. | | |
| | | | Note: If this file is | | |
| | | | merged more than | | |
| | | | once, this is the date of | | |
| | | | the last time it was | | |
| | | | merged. | | |
| Name can be arbitrarily | Joe D. Bozo | Contributor | Name of the | When Contributor | Sent.xls that |
| selected | <joe@bozo.com> | Reply Key | Contributor as set in | returns the | Contributor |
| | | | the Contributors copy | workbook. | has |
| | | | of software. | | |
| Name can be arbitrarily | 1999-04-28 18.30.44 | Contributor | Date and time the | When Contributor | Sent.xls that |
| selected | | Returned Dated | Contributor returned | returns the | Contributor |
| | | | the workbook. | workbook. | has |
| Name can be arbitrarily | | Contributor | Serial Number of the | When Contributor | Sent.xls that |
| selected | | Serial Number | Contributors copy of | returns the | Contributor |
| | | | Distributed | workbook. | has |
| | | | Spreadsheet. | | |
| Name can be arbitrarily | E | Contributor | How the Contributor | When Contributor | Sent.xls that |
| selected | (E = Email, F = File) | Replied Via | send the workbook | returns the | Contributor |
| | | | back. | workbook. | has |

### Conclusion

From the foregoing, it can be seen that the method and system of the present invention possesses the advantages discussed above. Additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

What is claimed is:

1. A method for distributing and collecting information for an electronic workbook that includes a plurality of worksheets, the method comprising:
assigning a contributor to a worksheet of the workbook by associating with the worksheet identifying information for the contributor;
associating with the worksheet distribution information for distributing the worksheet; and
distributing the worksheet to the assigned contributor based on the identifying information and the distribution information.

2. The method of claim I wherein associating with the worksheet identifying information for the contributor comprises embedding the identifying information in the worksheet.

3. The method of claim 2 wherein embedding identifying information in the worksheet comprises storing one or more name-value pairs within the worksheet.

4. The method of claim 3 wherein storing one or more name-value pairs within the worksheet comprises storing a name-value pair having the contributor's name.

5. The method of claim 4 wherein storing one or more name-value pairs within the worksheet further includes storing an email address for the contributor.

6. The method of claim I wherein associating with the worksheet distribution information for distributing the worksheet comprises storing one or more name-value pairs within the workbook.

7. The method of claim 6 wherein storing one or more name-value pairs within the workbook comprises storing in the workbook one or more name-value pairs that include one or more of a distributor's name, a distributor's email address, a distributor's reply email address, special instructions, a master workbook name, a master workbook date, a due back date, information regarding how the workbook will be distributed and distribution status.

8. The method of claim 6 wherein storing one or more name-value pairs within the worksheet comprises storing a name-value pair having the distributor's name and information identifying a medium for distributing the worksheet.

9. The method of claim 1 further comprising packaging the worksheet to restrict viewing of the worksheet to the assigned contributor before distributing the worksheet to the assigned contributor.

10. The method of claim 1 further comprising encrypting the worksheet before distributing the worksheet to the assigned contributor.

11. The method of claim 1 wherein associating with the worksheet distribution information for distributing the worksheet includes associating with the worksheet information for receiving returned contributions to the worksheet.

12. The method of claim 11 wherein associating with the worksheet information for receiving returned contributions to the worksheet includes embedding information in the returned contribution for receiving the returned contribution.

13. The method of claim 12 wherein embedding information in the returned contribution includes storing one or more name-value pairs within the returned contribution.

14. The method of claim 13 wherein storing one or more name-value pairs within a returned contribution includes storing in the contribution one or more name-value pairs that include one or more of a contributor replied date, a contributor reply key, a contributor returned date, and information regarding how the contribution was returned.

15. The method of claim 11 further comprising collecting a returned contribution to the worksheet and associating the returned contribution with the workbook.

16. The method of claim 15 wherein collecting the returned contribution includes using the information embedded in the returned contribution to associate the contribution with the workbook.

17. The method of claim 15 further comprising decrypting the contribution.

18. The method of claim 15 wherein collecting an assigned contributor's contribution includes automatically reading the distributor's email inbox to identify email messages that include returned contributions to a worksheet.

19. The method of claim 15 further comprising selectively merging the associated contribution with the workbook to create a merged workbook.

20. The method of claim 19 wherein selectively merging the associated contribution with the workbook to create a merged workbook includes making a temporary copy of the merged workbook.

21. The method of claim 20 further comprising saving the temporary copy of the merged workbook as a new workbook.

22. A system for collecting and distributing information for an electronic workbook that includes a plurality of worksheets, the system comprising:
a storage device for storing the electronic workbook; and
a processor programmed to work in cooperation with the storage device to:
assign a contributor to a worksheet of the workbook by associating with the worksheet identifying information for the contributor;
associate with the worksheet distribution information for distributing the worksheet; and
distribute the worksheet to the assigned contributor based on the identifying information and the distribution information.

23. The system of claim 1 wherein the processor programmed to associate with the worksheet identifying information for the contributor is programmed to embed the identifying information in the worksheet.

24. The system of claim 23 the processor programmed to embed identifying information in the worksheet is programmed to store one or more name-value pairs within the worksheet.

25. The system of claim 24 wherein the processor programmed to store one or more name-value pairs within the worksheet is programmed to store a name-value pair having the contributor's name.

26. The system of claim 25 wherein the processor programmed to store a name-value pair having the contributor's name is programmed to store an email address for the contributor.

27. The system of claim 22 wherein the processor programmed to associate with the worksheet distribution information for distributing the worksheet is programmed to store one or more name-value pairs within the workbook.

28. The system of claim 27 wherein the processor programmed to store one or more name-value pairs within the workbook is programmed to store in the workbook one or more name-value pairs that include one or more of a distributor's name, a distributor's email address, a distributor's reply email address, special instructions, a master workbook name, a master workbook date, a due back date, information regarding how the workbook will be distributed and distribution status.

29. The system of claim 27 wherein the processor programmed to store one or more name-value pairs within the workbook is programmed to store a name-value pair having the distributor's name and information identifying a medium for distributing the worksheet.

30. The system of claim 22 wherein the processor is further programmed to package the worksheet to restrict viewing of the worksheet to the assigned contributor before distributing the worksheet to the assigned contributor.

31. The system of claim 22 wherein the processor is further programmed to encrypt the worksheet before distributing the worksheet to the assigned contributor.

32. The system of claim 22 wherein the processor programmed to associate with the worksheet distribution information for distributing the worksheet is programmed to associate with the worksheet information for collecting returned contributions to the worksheet.

33. The system of claim 32 wherein the processor programmed to associate with the worksheet information for collecting returned contributions to the worksheet is programmed to read embedded information in a returned contribution for receiving the returned contribution.

34. The system of claim 33 wherein the processor programmed to read embedded information in the returned contribution is programmed to read one or more name-value pairs stored within the returned contribution.

35. The system of claim 34 wherein the one or more name-value pairs stored within the returned contribution include one or more of a contributor replied date, a contributor reply key, a contributor returned date, and information regarding how the contribution was returned.

36. The system of claim 32 wherein the processor is further programmed to collect a returned contribution to the worksheet and associate the returned contribution with the workbook.

37. The system of claim 36 wherein the processor programmed to collect a returned contribution to the worksheet and associate the returned contribution with the workbook is programmed to use the information embedded in the returned contribution to associate the contribution with the workbook.

38. The system of claim 36 wherein the processor is programmed to decrypt the contribution.

39. The system of claim 36 wherein the processor programmed to collect a returned contribution is programmed to automatically read the distributor's email inbox to identify email messages that include returned contributions to a worksheet.

40. The system of claim 36 wherein the processor is further programmed to selectively merge the associated contribution with the workbook to create a merged workbook.

41. The system of claim 40 wherein the processor programmed to selectively merge the associated contribution with the workbook to create a merged workbook is programmed to make a temporary copy of the merged workbook.

42. The system of claim 41 wherein the processor programmed to make a temporary copy of the merged workbook is further programmed to save the temporary copy of the merged workbook as a new workbook.

43. An electronic workbook comprising at least one worksheet, the worksheet including embedded information for assigning a contributor to the worksheet.

44. The electronic workbook of claim 43 wherein the embedded information in the worksheet includes one or more name-value pairs stored in the workbook.

45. The electronic workbook of claim 44 wherein the one or more name-value pairs stored within the workbook include a name-value pair including the contributor's name.

46. The electronic workbook of claim 45 wherein the name-value pair including the contributor's name also includes an email address for the contributor.

47. An electronic workbook comprising at least one worksheet, the workbook including embedded information for distributing the workbook.

48. The electronic workbook of claim 47 wherein the embedded information comprises one or more name-value pairs stored within the workbook.

49. The electronic workbook of claim 48 wherein the one or more name-value pairs stored within the workbook include one or more of a distributor's name, a distributor's email address, a distributor's reply email address, special instructions, a master workbook name, a master workbook date, a due back date, information regarding how the workbook will be distributed and distribution status.

50. The electronic workbook of claim 47 wherein the embedded information for distributing the workbook includes information for receiving returned contributions to the worksheet.

51. A contribution to an electronic workbook having at least one worksheet, the contribution including embedded information for returning the contribution to a distributor of the workbook.

52. The contribution of claim 51 wherein the embedded information includes one or more name-value pairs stored within the contribution.

53. The contribution of claim 52 wherein the one or more name-value pairs include one or more of a contributor replied date, a contributor reply key, a contributor returned date, and information regarding how the contribution will be returned.

54. An electronic workbook comprising at least one worksheet, the worksheet including embedded information for distributing the workbook and collecting contributions to the workbook, the workbook having stored therein one or more name-value pairs that include one or more of an assigned contributor's name, an email address for the assigned contributor, a distributor's name, a distributor's reply email address, special instructions, a master workbook name, a master workbook date, a due back date, information regarding how the workbook will be distributed, distribution status, information regarding when and how a contributor returned a contribution, information regarding when a distributor collected contributions and information regarding when a distributor merged contributions.
